(19) United States
(12) Patent Application Publication
(10) Pub. No.: US 2013/0277281 A1
(43) Pub. Date: Oct. 24, 2013

(54) Nanostrong vibratory screens & separators

(71) Applicant: Guy L. McClung, III, San Antonio, TX (US)

(72) Inventor: Guy L. McClung, III, San Antonio, TX (US)

(21) Appl. No.: 13/815,307

(22) Filed: Feb. 19, 2013

Related U.S. Application Data
(60) Provisional application No. 61/633,980, filed on Feb. 21, 2012.

(51) Int. Cl. B07B 1/46; B07B 1/34

(52) U.S. Cl. CPC B07B 1/46; B07B 1/34; Y10S 977/902; B82Y 30/00
USPC 209/346; 209/408; 977/902

(57) ABSTRACT

Vibratory separators, shale shakers, screens, and screen assemblies, and screening material with nanomaterial thereon and/or therein for strengthening, conductivity enhancement, or both, and methods of using such things. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### RELATED APPLICATION

The present invention and this application claim the benefit of priority under the patent Laws of U.S. Application Ser. No. 61/633,980 filed Feb. 21, 2012, said application incorporated fully herein for all purposes.

### BACKGROUND OF THE INVENTION

1. Field of the Invention

The present invention is directed to: vibratory separators; screens used with them; shale shakers; screens used with them; frames, supports, grids, strips, and plates for such screens; adhesives for use with such screens; materials and methods for making such screens and such frames, etc.; and materials for such screens and frames, etc. with nanomaterial thereon and/or dispersed therein for strength and/or for enhanced conductivity (thermal, electric, of mechanical force).

2. Description of Related Art

Vibratory separators are used in a wide variety of industries to separate materials such as liquids from solids, solids from slurries, solids from fluids, or solids from solids. Typically such separators have screen holding structure, e.g., a basket or screen mounting apparatus, mounted in or over a receiving receptacle, reservoir, or tank and vibrating apparatus for vibrating the screen holding structure and the screen(s). One or more screens are mounted in the basket. Material is introduced to the screen(s) either by flowing it directly onto the screen(s) or by flowing it into a receptacle, e.g, a container, tank, or “possum belly” from which it then flows to the screen(s). Also in some multi-screen apparatuses material flows from an upper screen onto a lower screen. Some material that does not pass through the screen(s) flows off the top of the screen(s) and some material, e.g. fluid, passes through the screen(s) into the receptacle.

At some point, due to screen wear and degradation, and sometimes due to damage to a screen, screens are periodically replaced. Fluid alone and/or abrasives and solids in some fluids can wear away parts of a screen, e.g., a screen support and/or screening material itself. There is a need, recognized by the present inventor, for strong, efficient and effective screens for vibratory separator systems and shale shakers which do not wear out as frequently as existing screens. There is a need, recognized by the present inventor, for efficient and cost-effective screening material supports and screens with such a support with resulting reduced wear to supports, to screening material, and in screen material introduction areas; and for screens which need not be repaired or replaced as frequently as certain prior art screens.

### SUMMARY OF THE PRESENT INVENTION

The present invention discloses, in certain aspects, a screen for a separator or shaker which has a support and screening material connected to the support. Material connecting the screening material to the support has strengthening nanomaterial therein. This connecting material may be any known glue, epoxy, plastic, welding material, bonding material, fiberglass, sewing material, composite material, epoxy system or/and adhesive (all collectively referred to herein as “adhesive material” or “connecting material”) to which has been added strengthening nanomaterial. In certain aspects, these are NANOSTRONG (trademark) screens, shakers, and separators

Any desired amount of the nanomaterial may be used to effect any desired increase in strength of material herein, including the connecting material; e.g., but not limited to, the nanomaterial present as 0.1 to 2 wt. percent of the total mass of the connecting material, and, in another aspect, is thus present as 1.0 to 5.0 wt. percent. Any suitable nanomaterial may be used, including, but not limited to, carbon nanotubes, e.g., but not limited to, single-walled carbon nanotubes, multi-walled carbon nanotubes, or a combination thereof. “Nanomaterial” as used herein includes any suitable known nanomaterial or combination of nanomaterial that effects the desired strengthening of a material and/or the desired enhancement of conductivity. “Nanomaterial” includes, but is not limited to: nanotubes, nanostructures, nanocomposites, nanopastes, nanohorns, coated nanomaterial, nanomatrices, ceramic nanomatrices, nanoplatlets, nanoflakes, carbon nanotubes (CNTs), single-wall carbon nanotubes (SWNTs), multi-wall carbon nanotubes (MWNTs), double-wall carbon nanotubes (DWNTs), buckytubes, small-diameter carbon nanotubes, fullerene tubes, tubular fullerenes, graphite fibrils, carbon nanofibers, and combinations thereof; such nanotubes and carbon nanotubes can be of a variety and range of suitable lengths, diameters, number of tube walls, and chiralities (helicities), and can be made by any suitable known technique; the nanotubes may be functionalized using any known functionalization; the nanotubes may be initially in a suitable known solution or dispersion; the nanotubes may be purified or unpurified; CNTs may include purified CNTs, unpurified CNTs (raw, as-produced), and combinations thereof. In some such embodiments, the CNTs are selected from the group including SWNTs, MWNTs, carbon nanofibers, CNTs in elastomeric nanocomposites; nanomaterial present in ranges from about 0.0001 wt. % to about 90 wt. %; in other aspects, the amount of CNTs is relatively low, i.e., 4 wt. %; some, all, or at least some of the nanomaterial, e.g., CNTs, are functionalized in a manner selected from the group including sidewall functionalization and end functionalization, and combinations thereof; the amount of functionalized nanomaterial or CNTs can range from about 0.0001 weight percent to about 90 weight percent of the weight of a resulting material or nanocomposite; and/or the nanomaterials may have have a diameter in the range 10-500 nm, a diameter in the range 100 to 150 nm and/or a length in the range 1-10 mumicrons; and/or any nanomaterial disclosed in any patent or application mentioned herein and/or any nanomaterial mentioned in or described in U.S. Pat. Nos. 8,038,479; 7,097,820; 8,084,012; 8,038,479; 8,080,487; 8,105,964 8,096,353; 8,096,353; 6,537,515; 7,581,645; 6,420,293; 8,084,505; and/or in U.S. patent application Ser. Nos. 12/243,165; 11/973,465; 12/430,265; 11/577,750; 12/282,408; and/or 12/847,594

The use of such nanomaterial, e.g., in connection material for connecting screening material to a support of a screen useful with vibratory separators and shale shakers, in addition to strengthening a screen, make it possible to use relatively less connection material to connect screening material to a screen, thereby providing relatively more open screening area for screening material to be treated by a separator or shaker.

Use of such adhesives according to the present invention also makes possible the use of screening supports (e.g, plates, frames, grids, unibody structures, and strip supports) which have relatively larger openings without sacrificing the needed strength to withstand the significant forces imparted to screens by the vibratory motors of separators and shakers.

For any embodiment herein in which there is nanomaterial, whether described as “strengthening” nanomaterial or not, the nanomaterial may be for enhancing conductivity, including thermal conductivity, electrical conductivity, and/or mechanical force conductivity; and the amount of such nanomaterial used is sufficient to effect the desired enhancement in conductivity.

The present invention discloses, in certain aspects, supports for screening material of a screen useful with vibratory separators and shale shakers. These supports (e.g, plates, frames, unibody structures, grids, and strip supports) are made from support materials that contain nanomaterial that provides strength. The use of such supports make it possible to use relatively less support material in a support thereby providing relatively more open area over which screening material is located to enhance the efficiency of treated fluid or material with a separator or shaker; or, the mass of a support according to the present invention is like that of known supports, but, due to the presence of the nanomaterial, the supports according to the present invention are significantly stronger.

Any desired amount of the nanomaterial may be used to effect any desired increase in strength of the support material; e.g., but not limited to, the nanomaterial present as 0.1 to 2 wt. percent of the total mass of the support material, and, in another aspect, is thus present as 1.0 to 5.0 wt. percent. Any suitable nanomaterial may be used, including, but not limited to, carbon nanotubes, e.g., but not limited to, single-walled carbon nanotubes, multi-walled carbon nanotubes, or a combination thereof.

Use of such supports according to the present invention also makes possible the use of relatively larger openings in such supports without sacrificing the needed strength to withstand the significant forces imparted to supports and screens with such supports by the vibratory motors of separators and shakers.

In certain aspects, the present invention discloses a screen assembly for a vibratory separator, the screen assembly including: a support, the support having a body, the body with two pairs of opposed sides including a first pair with a first side parallel to a second side and a second pair with a third side parallel to a fourth side; screening material on the support for screening fluid or material introduced to a separator or shaker; and adhesive connecting the screening material to the support, the adhesive containing nanomaterial to strengthen the adhesive and the connection of the screening material to the support and/or to enhance conductivity. Optionally, the support has nanomaterial strengtheners.

“Adhesive” includes, inter alia, any connecting material used to adhesively connect screen to support, e.g., and not by way of limitation, glue, epoxy, epoxy systems, and bonding materials.

Optionally, the screening material layers may be connected together and/or to the support by sintering, bonding, by sewing with thread strengthened with nanomaterial, and/or welding with a method that uses welding material that includes strengthening nanomaterial. Welding material and sewing material may have any desired amounts of nanomaterial used to effect any desired increase in strength of the material; e.g., but not limited to, the nanomaterial present as 0.1 to 2 wt. percent of the total mass of the welding or sewing material, and, in another aspect, is thus present as 1.0 to 5.0 wt. percent. Any suitable nanomaterial may be used, including, but not limited to, carbon nanotubes, e.g., single-walled carbon nanotubes, multi-walled carbon nanotubes, or a combination thereof.

It is within the scope of the present invention to use no support or to delete the support from an existing screen and use the connecting material to connect multiple layers of screening material together; or, when there is a single layer of screening material, to make a pattern on the screen with the connection material to provide support.

Any screen according to the present invention may have a single layer of screening material or two, three or more layers one on top of the other; and any adjacent layers or multiple layers may be connected together with connection material according to the present invention.

In certain aspects, the present invention discloses plastic grids for fusing together layers of a screen's screening material. The grid contains strengthening nanomaterial. Plastic of the grid may have desired amount of nanomaterial used to effect any desired increase in strength of the grid; e.g., but not limited to, the nanomaterial present as 0.1 to 2 wt. percent of the total mass of the grid, and, in another aspect, is thus present as 1.0 to 5.0 wt. percent. Any suitable nanomaterial may be used, including, but not limited to, carbon nanotubes, e.g., but not limited to, single-walled carbon nanotubes, multi-walled carbon nanotubes, or a combination thereof. The same is true for any wire, fiber, filament, or rod used in any screening layer or media or mesh in embodiments of the present invention.

In certain aspects, the present invention provides a vibratory separator or a shale shaker that employs one or a plurality of screens according to the present invention.

In certain aspects, the present invention provides methods for using a screen or screens according to the present invention and methods for using a vibratory separator or a shale shaker that employs one or a plurality of screens according to the present invention.

In certain aspects, the present invention provides a method for treating material with a vibratory separator or shale shaker, the method including introducing material to be treated to a vibratory separator or shaker having a screen mounting structure and a screen or screens according to the present invention and separating components of the material with the vibratory separator or shaker. The parts of a vibratory separator or shale shaker may, according to the present invention, have a desired amount of the nanomaterial used to effect any desired increase in strength of the part (e.g., but not limited to basket, lower receptacle or reservoir, spring mounts, screen mounting structure or apparatus, motor mounts, motor housings, and base); e.g., but not limited to, the nanomaterial present as 0.1 to 2 wt. percent of the total mass of the mass of the part, and, in another aspect, is thus present as 1.0 to 5.0 wt. percent. Any suitable nanomaterial may be used, including, but not limited to, carbon nanotubes, e.g., but not limited to, single-walled carbon nanotubes, multi-walled carbon nanotubes, or a combination thereof.

In certain embodiments, the present invention provides a shale shaker or vibratory separator which, in one aspect, has a base, vibration isolation apparatus on the base, a basket, a screen or screens mounted on or in the basket, mount apparatus for mounting the basket on the base, and all of or at least one of the base, basket, screen(s), and the mount apparatus made of, encased in, or coated with composite material which includes nanomateral dispersed therein.

It is within the scope of the present invention, where it is not a contradiction to a stated description, for any layer or layers of screening material in any embodiment herein to be flat or to be non-flat, often referred to as a “3-D” layer or screen. The present invention provides improvements to known 3-D screens including the provision of screen supports with nanomaterial dispersed therein; the provision of adhesives, including, but not limited to, epoxy and plastic, with nanomaterial therein; and screen material with nanomaterial therein.

It is within the scope of the present invention to coat a screen with a coating that includes nanomaterial dispersed therein and material to make the screen surface slicker—i.e., to provide a surface such that material flowing over the surface and/or through a screening layer does not as readily adhere to the surface or screen when the coating is absent. Such a coating may be applied over the entire surface of a screen or it may be applied to lines or areas of adhesive that are on a screen layer or project above a screen layer or layers. It is within the scope of the present invention for any embodiment disclosed herein for the adhesive as described and/or as shown to have, be or to include such coating material. Any adhesive described as at the level of the top surface or a top layer of screening material, or projecting above such a top surface, may have a coating thereon according to the present invention that renders the surface of the adhesive slicker.

The present invention provides a vibratory separator, shale shaker part or a shale shaker screen part with the part made from material with nanomaterial dispersed therein, the part having an erosion resistant surface (e.g., as in U.S. Pat. No. 7,968,184). In one aspect the erosion resistant surface has an array of elastic whiskers which, inter alia, slow the velocity of erosive particles before impacting with the surface of the separator, shaker, or screen part. In one aspect, the erosion resistant forest includes a nanotube forest, e.g., but not limited to, a carbon nanotube forest, is placed on, adhered to, deposited on, or grown on the surface to provide erosion resistance. Optionally, such a forest is on a flexible substrate that is connected to or bonded to the surface.

The present invention provides a part of a vibratory separator, shake shaker, or a part of a screen for a separator or shaker which is made of base material with nanomaterial dispersed therein with an erosion resistant surface on a surface of the part that is exposed to erosive material and/or to erosive flow.

In certain aspects the present invention provides improvements to the subject matter of U.S. Pat. No. 7,968,184 (incorporated fully herein for all purposes) including a part as described in the previous paragraph with an erosion resistant surface for any separator, shaker, or screen part of the subject matter according to the present invention with nanomaterial dispersed therein (any nanomaterial disclosed herein). This patent has no teaching, motivation, or suggestion to make a separator part, shale shaker part, or screen part with such nanomaterial according to the present invention.

Accordingly, the present invention includes features and advantages which are believed to enable it to advance separation technology and screening technology. Characteristics and advantages of the present invention described above and additional features and benefits will be readily apparent to those skilled in the art upon consideration of the following description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions of embodiments preferred at the time of filing for this patent that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain embodiments of the invention, other objects and purposes will be readily apparent to one of skill in this art who has the benefit of this invention's teachings and disclosures. It is, therefore, an object of at least certain embodiments of the present invention to provide the embodiments and aspects listed above, those described below, and:

New, useful, unique, efficient, nonobvious screens for separators and shakers and methods of their use;

New, useful, unique, efficient, nonobvious screen parts, e.g., supports and/or screening material and/or connection material with strengthening nanomaterial and/or conductivity enhancing nanomaterial.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly, from a cursory inspection or review, the nature and general area of the disclosure of this invention. The Abstract is neither intended to define the invention, which is done by the claims, nor is it intended to be limiting of the scope of the invention or of the claims in any way. It will be understood that the various embodiments of the present invention may include one, some, or all of the disclosed, described, and/or enumerated improvements and/or technical advantages and/or elements in claims to this invention.

Certain aspects, certain embodiments, and certain preferable features of the invention are set out herein. Any combination of aspects or features shown in any aspect or embodiment can be used except where such aspects or features are mutually exclusive.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate embodiments preferred at the time of filing for this patent and are not to be used to improperly limit the scope of the invention which may have other equally effective or legally equivalent embodiments.

FIG. 1 is a schematic representation of openings of a screen support.

FIG. 2 shows schematically the support of FIG. 1 with the openings' areas crosshatched.

FIG. 3 is a schematic representation of openings of a screen support according to the present invention.

FIG. 4 shows schematically the support of FIG. 3 with the openings' areas crosshatched.

FIG. 5 is a top view of a screen according to the present invention.

FIG. 6A is a top perspective view of a screen assembly according to the present invention.

FIG. 6B is a cross-section view of the screen assembly of FIG. 6A.

FIG. 7 is a cross-section view of a screen according to the present invention.

FIG. 8 is a cross-section view of a screen according to the present invention.

FIG. 9A is a top perspective view of a screen assembly shown for comparison to a screen assembly according to the present invention.

FIG. 9B is a cross-section view of bead of adhesive of the screen assembly of FIG. 9A.

FIG. 10A is a top perspective view of a screen assembly according to the present invention.

FIG. 10B is a cross-section view of bead of adhesive of the screen assembly of FIG. 10A.

FIG. 11 is a top perspective view of a screen assembly according to the present invention.

FIG. 12 is a top view of a screen assembly according to the present invention.

FIG. 13A is a top perspective view of a screen assembly according to the present invention.

FIG. 13B is a top view of the screen assembly of FIG. 13A.

FIG. 13C is an end view of the screen assembly of FIG. 13A.

FIG. 13D is an side view of the screen assembly of FIG. 13A.

FIG. 14A is a top view of a screen according to the present invention.

FIG. 14B is an exploded side view of the screen of FIG. 14A.

FIG. 15 is a perspective view of a shale shaker with a screen according to the present invention.

FIG. 16 is a schematic view of a shale shaker system with a screen according to the present invention.

FIG. 17 is a schematic view of a shale shaker with a screen according to the present invention.

FIG. 18 is a schematic perspective view of a screen according to the present invention.

FIG. 19A is a top perspective view of a support for a screen assembly according to the present invention.

FIG. 19B is a top view of a member with nanomaterial for application to the support of FIG. 19A for a screen assembly of FIG. 13A.

FIG. 19C is a top view showing the member of FIG. 19B on the support of FIG. 19A.

FIG. 19D is a top view of a screen assembly according to the present invention with the support of FIG. 19A and the member of FIG. 19B

FIGS. 20A and 21A are schematic views of production steps in methods for making a screen assembly according to the present invention.

FIGS. 20B and 21B are schematic views of optional further steps in the making of a screen assembly.

FIG. 22A is a top perspective view of a frame support for a screen assembly according to the present invention.

FIG. 22B is a top view of the support of FIG. 22A with adhesive applied thereto.

FIG. 22C is top perspective view of the support of FIG. 22B with nanomaterial applied thereto.

FIG. 22D is a top perspective view of a screen assembly made according to the steps of FIGS. 22B and 22C.

FIG. 23A is a top perspective view of a screen assembly according to the present invention.

FIG. 23B is a top view of screening material member for connection to the frame support of FIG. 23A for a screen assembly according to the present invention.

FIG. 23C is a top perspective view of a screen assembly according to the present invention with a member as shown in FIG. 23B.

FIG. 24A is a schematic top perspective view of a method for applying nanomaterial to a screen assembly according to the present invention.

FIG. 24B is a schematic top perspective view of a dvreen support with nanomaterial applied with a method according to the present invention.

FIG. 25A is a schematic partial top perspective view of a screen assembly according to the present invention.

FIG. 25B is a cross-section view of the screen assembly of FIG. 25A.

FIG. 25C is a schematic partial top perspective view of a screen assembly according to the present invention.

FIG. 26A is a top view of a screen assembly support according to the present invention.

FIG. 26B is a top view of a screen assembly support according to the present invention.

FIG. 26C is a top view of a screen assembly support according to the present invention.

FIG. 27A is a top view of a screen assembly according to the present invention.

FIG. 27B is a top view of a screen assembly according to the present invention.

FIG. 28 is a perspective view of a shale shaker in accordance with the present invention.

FIG. 29A is a top view of a structural member for a shale shaker in accordance with the present invention.

FIG. 29B is a side cross-section view of the member of FIG. 29A.

FIG. 30 is a cross-section views of a part of a shale shakers in accordance with the present invention.

FIG. 31A is a perspective view of a plastic undulating screen of the present invention.

FIG. 31B is an enlarged view of part of the screen of FIG. 31A.

FIG. 32 shows a three dimensional view, from above, of a screening module, in accordance with the present invention.

FIG. 33A is a fragmentary plan view of one embodiment of a screen assembly of the present invention with portions broken away to show various layers thereof.

FIG. 33B is a fragmentary enlarged cross sectional view taken substantially along line 33B-33B of FIG. 33A and showing the construction at the ends of the screen supporting plate for securing the vibratory screen in a shaker or vibratory screening machine.

FIG. 33C is an exploded perspective view showing the components of one embodiment of the screening portion of a screen assembly as shown in FIG. 33A prior to being bonded together.

FIG. 34 is a side schematic cross-section view (not to scale) of a part according to the present invention (which may be a part of a separator, shaker, or screen).

FIG. 35 is a schematic view of methods according to the present invention.

Certain embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive.

It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiments, and are not intended to mean the claimed invention of any particular appended claim(s) or all of the appended claims.

Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein. The drawing figures present the embodiments preferred at the time of filing for this patent.

### DETAILED DESCRIPTION OF THE INVENTION

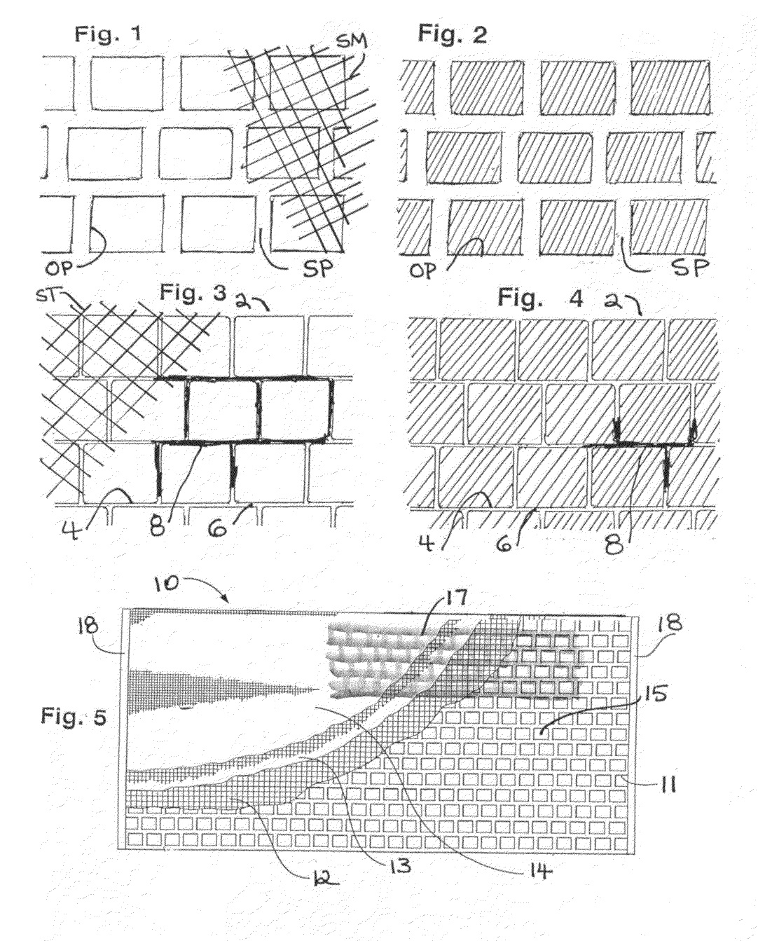

FIGS. 1 and 2 illustrate openings OP in a screen support SP (shown partially). The openings have a measurable opening area and the amount of the support mass between openings is also measureable. A component or components of material, e.g., fluid or slurry, to be treated by a separator or shaker with a screen with a support like the support SP can flow to and through screening material SM (shown partially, FIG. 1) over the openings OP. Such component(s) cannot flow through the screen support mass around the openings. Some components (or a component) pass through the screening material SM. It is within the scope of the present invention, for a screen according to the present invention to have a support according to the present invention with the dimensions, openings, and spacing of the support SP.

FIGS. 3 and 4 illustrate a screen support 2 according to the present invention with openings 4 therethrough. The screen support 2 has amounts of its mass 6 between the openings 4. The support 2 may be made with materials like a known support and connecting material 8 (which covers the entire support, but which is shown partially with darker lining) with strengthening nanomaterial used to connect screening material to the support; or the support 2 may be made with materials as those used in a known support supplemented with strengthening nanomaterial and the connecting material 8 may be any suitable known connecting material; or both the support and the connecting material may include strengthening nanomaterial. Screening material ST (shown partially) covers the support 2.

FIG. 5 shows a screen 10 according to the present invention which has a support that is a perforated plate 11 with openings 15 on which are mounted three layers 12, 13, and 14 of mesh or screening material. Any of the layers may be deleted. The plate 11 has optional screen mounting apparatus, e.g., hookstrips 18, on two of its sides for mounting the screen 10 to suitable shale shakers or vibratory separators.

The screen 10, but with improvements according to the present invention, may be like screens disclosed in U.S. Pat. Des. No. 366,040 and U.S. Pat. No. 5,971,159 (both incorporated fully herein for all purposes).

Connecting material 17 (shown as shading partially covering the screen; but to be understood as on the entire plate) is any connecting material according to the present invention that has strengthening nanomaterial; or, optionally the supporting plate 11 includes strengthening nanomaterial and the connecting material does not; or both the connecting material and the plate have such nanomaterial. Optionally, some or all of the screening material is made with wire, fibers, filaments, and/or rods with strengthening nanomaterial.

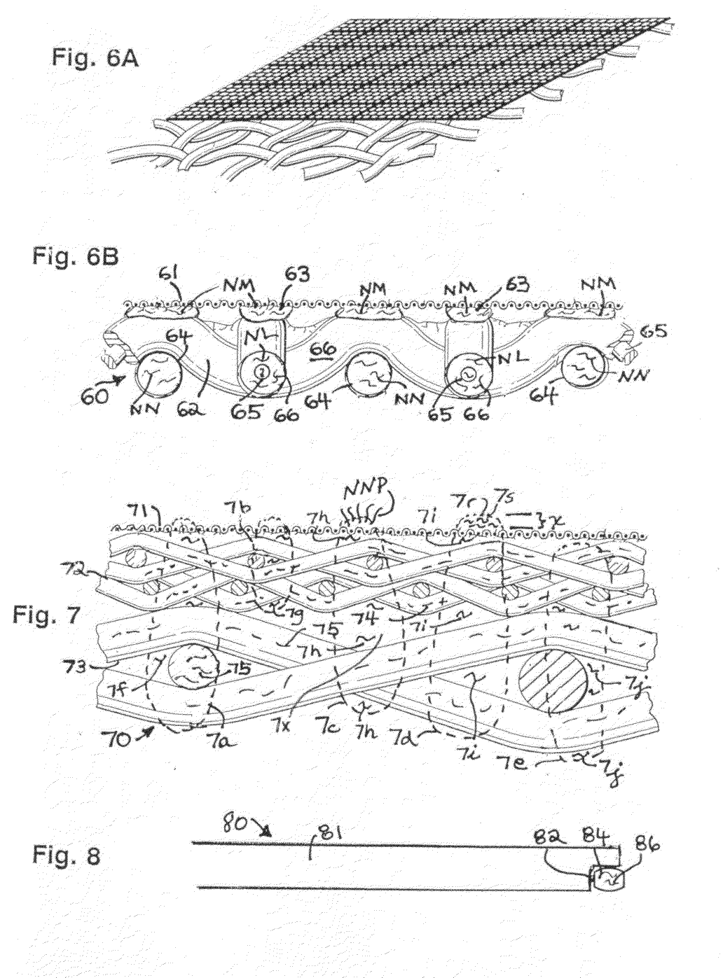

FIGS. 6A and 6B show a screen 60 with a top layer 61 connected to a bottom layer 62 with adhesive material 63 that adheres to both layers. Any suitable adhesive can be used for the adhesive material 63. Dispersed within the adhesive material 63 is strengthening nanomaterial NM (not to scale; no nanomaterial herein is shown to scale; and nanomaterial shown as lines or “squiggly” lines herein is meant to indicate nanomaterial on or within an object).

Optionally, (and as is true for any wire, filament, fiber, or rod of any screening material, mesh or media in any embodiment herein) wires 64 of the layer 62 contain nanomaterial NN dispersed throughout. Optionally, (and as is true for any wire, filament, fiber, or rod of any screening material, mesh or media in any embodiment herein) any wire, etc., herein may be coated, e.g., with a coating 66 which contains nanomaterial NL dispersed throughout. Optionally, (and as is true for any wire, filament, fiber, or rod of any screening material, mesh or media in any embodiment herein and for any support—e.g., grid, plate, frame, strips, etc.—herein) any wire, etc., herein may have sufficient nanomaterial used to enhance the wire's conductivity of electricity, heat or cold, stress, or force or energy.

FIG. 7 shows a screen assembly 70 according to the present invention which has a top layer 71, a middle layer 72, and a bottom layer 73. Optionally, any single layer is deleted. As is true for any screen or screen assembly disclosed herein, the layers may be of any mesh and of any opening size, with wires, filaments, fibers, or rods of any desired size and cross-section, in any desired weave or pattern. Any support herein may be used with the screen assembly 70, although none is shown in FIG. 7. If a support is used, the manner of application of adhesives described below may include adhesive in or on or around a support or part thereof.

Adhesive material used to connect layers together may be used and applied in a variety of ways; and any way illustrated is shown partially, but it is to be understood that such a manner of application can be for adhesive that covers an entire surface area of a screen, of a support, or a part. Adhesive 7a extends from the top of the screen assembly 70 to the bottom, encompassing wires in all three layers of the screen. The adhesive 7a has nanomaterial 7f therein and dispersed throughout the adhesive.

Adhesive 7b extends from the top of the screen assembly to the layer 72, encompassing wires in both layers of the screen. The adhesive 7b has nanomaterial 7g therein and dispersed throughout the adhesive.

Adhesive 7c extends from the top of the screen assembly to the layer 72, encompassing wires in both layers of the screen. The adhesive 7b has nanomaterial 7h therein and dispersed throughout the adhesive. Adhesive 7c has a portion 7x which is located in a space between portions of the layers 72 and 73 in which wires of these layers are not in contact.

Adhesive 7d extends from the top of the screen assembly 70 to the bottom, encompassing wires in all layers of the screen. The adhesive 7d has nanomaterial 7i therein and dispersed throughout the adhesive. As is true for any use of adhesive in any embodiment herein, and in applications of adhesive as in adhesives 7a-c and 7e, the adhesive 7d has a portion 7r projecting above the top layer 71 with added nanomaterial 7s. The adhesive amount 7r projects to a height x above the top of the top layer 71. The height x may be any desired height, e.g., but not limited to, between 0.03 inch and 0.7 inch; and, as is true for any application of adhesive herein, the width of the amount 7r may be any desired width. Optionally, there is no added nanomaterial 7s.

Adhesive 7e extends from the layer 72 to the bottom layer 73, encompassing wires in both layers of the screen. The adhesive 7e has nanomaterial 7j therein and dispersed throughout the adhesive.

Optionally, the wires of the layer 72 have nanomaterial 74 dispersed therein. Optionally, the wires of the layer 73 have nanomaterial 75 dispersed therein. Optionally, the wires of the layer 71 have nanomaterial (not shown) dispersed therein.

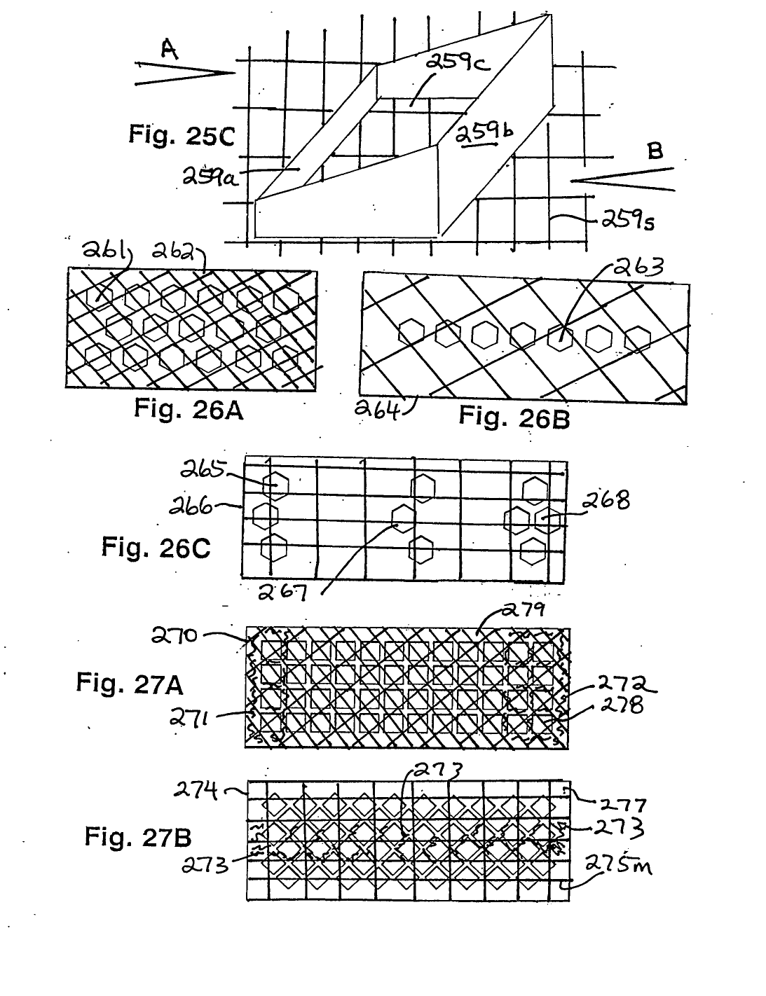

In any embodiment herein in which there is material and/or adhesive at a surface that is exposed to degrading or erosive materials and/or fluids, in which herein nanomaterial is shown or described as being at or near a surface, it is to be understood that nanomaterial may be partially embedded in material and/or adhesive and may partially project from the material and/or adhesive. The nanomaterial portions that project from the material or adhesive may contact solids in material or in a fluid that degrades or erodes the material in which the nanomaterial is embedded. For example, as shown in FIG. 7 nanomaterial NNP (e.g., but not limited to carbon nanotubes) is partially within adhesive 7c and portions of the nanomaterial NNP project from the adhesive 7c. This feature is also exhibited by the nanomaterial NNS, FIG. 10B and the nanomaterial NNT, FIG. 25B

It is within the scope of the present invention to provide a seal for use between screens or screen assemblies to seal an interface between them. Such a seal may have nanomaterial therein to strengthen the seal or to provide any of the conductivities described above. As shown schematically in FIG. 8, a screen assembly 80 with a support 81 has a recess 82 in which is located a seal 84 to seal an interface of the screen assembly with another adjacent screen assembly. The seal 84 has strengthening nanomaterial 86 dispersed therein.

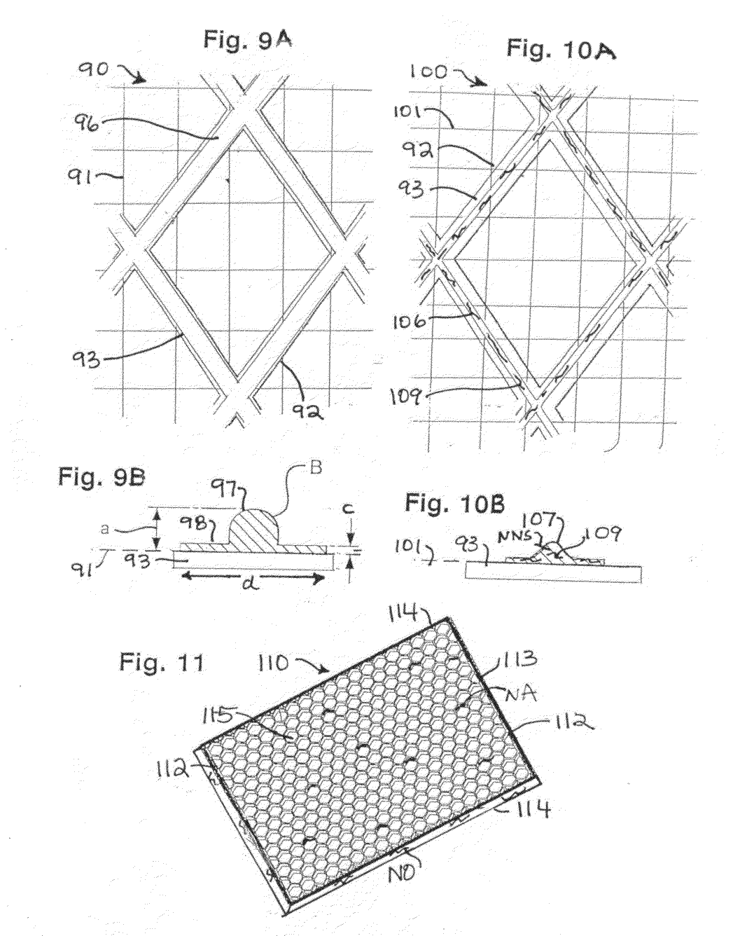

FIGS. 9A and 9B show schematically a screen 90 which can be a known screen. The screen 90 has screening material 91 on a grid 92 which is made of a network of grid members 93. Adhesive connects the screening material 91 to the grid 92. It is, however, within the scope of the present invention, for a screen according to the present invention to have a grid according to the present invention with the dimensions, openings, and spacing of the grid 92.

As shown, the members 93 have a width and the adhesive 96 is applied to a certain width on the members 93. As shown in FIG. 9B, a bead 97 of the adhesive 96 has particular dimensions, including a height a, a base 98 with a width d and a height c, and an upwardly projecting bulb B with a width and a height.

For the sake of comparison, as shown in FIGS. 10A and 10B a screen 100 has screening material 101 on a grid 92 with grid members 93. Adhesive 106 connects the screening material 101 to the grid 92. The adhesive 106 has strengthening nanomaterial 109 dispersed therein (not to scale). The adhesive 106 is applied to a certain width on the members 93 which is less than the width of application of the adhesive 96, FIG. 9A. As shown in FIG. 10B, a bead 107 of the adhesive 106 is smaller than the bead 97, FIG. 9B, illustrating that less adhesive is needed to connect the screening material to the grid when the adhesive has nanomaterial therein. Although the bead 107 is shown as smaller than the bead in multiple dimensions, it may be applied to be smaller in only one or some dimensions.

The present invention, in certain embodiments, provides a screen assembly for a vibratory separator or shale shaker in which a frame, panel, grid, strips, plates, or support for screening material of the screen assembly is made of composite material with strengthening nanomaterial. “Composite Material” includes a material, e.g., a fiberglass, composite, plastic or resin material, with reinforcing material (e.g. fibers, fibrils, pieces, strands, and/or powder) which is of a material of desired strength (e.g., but not limited to, carbon, fiberglass, plastic, metal, or mineral glass). In other aspects, the support is made of base material with strengthening nanomaterial; the base material being any suitable known material used for screen frames, strips, supports, grids, or plates. Openings in a frame, grid, support, plate, etc., according to the present invention may be any desired shape, e.g., but not limited to square, rectangular, trapezoidal, hexagonal, triangular, or diamond.

In certain aspects, a screen assembly according to the present invention has a screen support made of composite material with strengthening nanomaterial to which is secured a layer or layers of screening material. Any known layer or layer of screening material—flat or 3D—may be used for the layer(s). Optionally, a third and/or a fourth layer of screening material (any known) may be used. Any layers may be connected together and/or connected to the screen support in any known way.

One composite material useful for a frame, grid, or support according to the present invention is, by weight 35% to 40% NYLON 66 (trademark) material or 6,6 NYLON (trademark) material and 60% to 65% glass reinforcing material (or 60% to 65% glass reinforcing material plus minerals, e.g., quartz). In another aspect, instead of NYLON 66 (trademark) material, polyphenylene sulphide is used with carbon fibers.

In certain aspects, the nanomaterial is present in a desired amount to add a desired amount of strength and/or conductivity (e.g., conductivity of force, energy, electricity, or heat). In certain aspects (and as is true for any support, plate or frame according to the present invention) the nanomaterial is present as 0.1 to 2 wt. percent of the total mass of the support, etc; and, in another aspect, is thus present as 1.0 to 5.0 wt. percent.

FIG. 11 shows a screen support 110 made of plastic or of composite material according to the present invention which has a plurality of fluid flow openings 115 through a body 113. The body has ends 112 and sides 114. The body and/or ends 112 and/or sides 114 are made of plastic or of composite material that has dispersed therein strengthening nanomaterial NA (not to scale). The part of the body encompassed by the ends 112 and the sides 114 are made of plastic or of composite material that has dispersed therein and strengthening nanomaterial NO (not to scale).

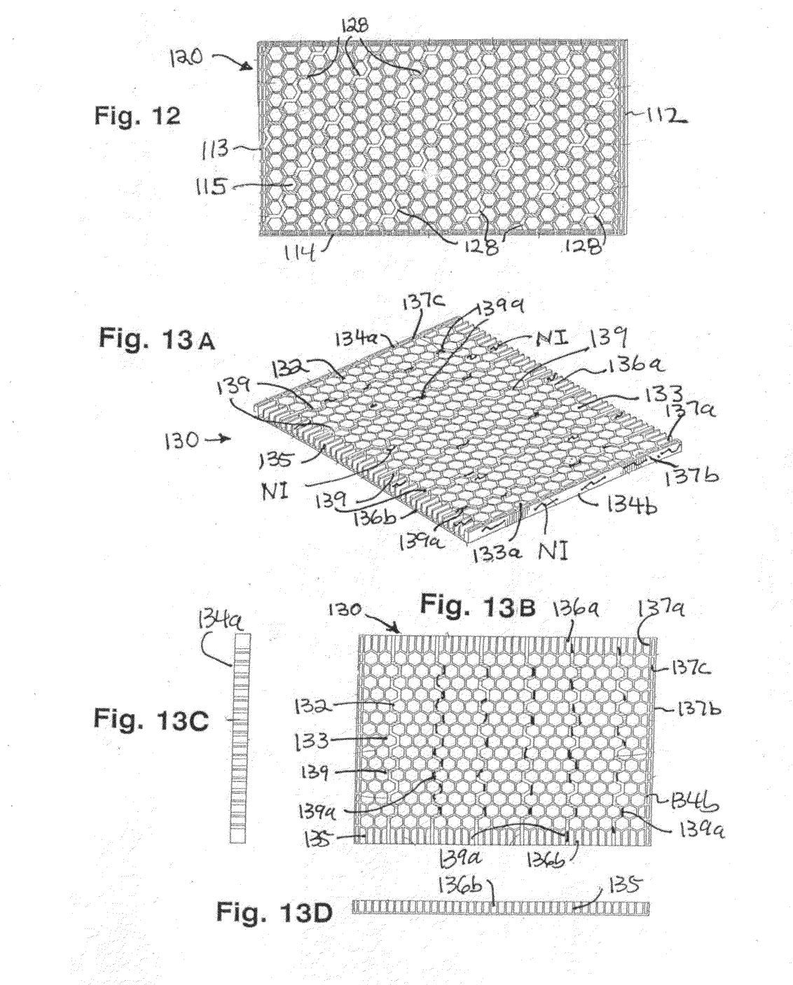

FIG. 12 shows a screen support 120 made of plastic or of composite material according to the present invention which is like the screen support 110, FIG. 11, and like numerals indicate like parts. The support 120 also has a plurality of spaced-apart members 128 which are on tops of parts of the support that define the openings 115. These members 128 may be at the same level or height as the rest of the support body or they may be raised as compared to the rest of the support body.

The members 128 may be made of the same material as the body 113. Alternatively, the members 128 are made of a material different from the body 113. The members 128 may be integral with the body 113 or they may be initially separate therefrom and then connected thereto. The members 128, as viewed from above, may be the same width as the parts of the body beneath the members 128; or, as shown, the members 128 may be wider than the parts of the body beneath the members 128. In one aspect, the body 113 has no strengthening nanomaterial and the members 128 do have strengthening nanomaterial. In another aspect, the body 113 has strengthening nanomaterial and the members 128 have strengthening nanomaterial. Optionally, the members 128 do not have nanomaterial.

The materials and structures of the support 120 may be (but with improvements according to the present invention) as disclosed in U.S. patent application Ser. No. 11/637,615, filed 12 Dec. 2006 which is incorporated fully herein for all purposes.

FIGS. 13A-13D show a screen support 130 according to the present invention. The screen support 130 has a body 132 with ends 134a and 134b spaced-apart by sides 136a and 136b. The body 132 has a plurality of fluid flow openings 133 therethrough. Some of the openings 133a at ends of the body are half the size of the openings 133. All or part of the screen support 130 has strengthening nanomaterial NI (not to scale) dispersed therein

The sides 24, 26 have optional bars. Optionally, each end of the body 12 has two members 137a, 137b spaced-apart by optional ribs 137c. The end portions of the members 32, 34 may have an opening therebetween or as shown may be closed off.

As shown, the support 130 may, optionally, have parts 139 which extend across the body 132 of the support and these parts may have nanomaterial 139a dispersed therein.

FIGS. 14A and 14B show a screen assembly 140 which has layers of screening material M, N on a perforated plate P with a plurality of fluid flow openings O (e.g. any known perforated plate used in known screen assemblies). Optionally, the plate P is placed on a support T with openings Y and connected and/or adhered (collectively referred to as “secured” together) thereto by any known way in which such a plate is connected and/or adhered to an item beneath the plate. In one particular aspect the plate P is placed with material to form the support T during the making of the support T. Any part of the screen assembly 140 may, according to the present invention, be strengthened with nanomaterial thereon and/or dispersed therein and/or have conductivity (any conductivity described above) or enhanced conductivity due to the addition of nanomaterial, including, but not limited to, wires of the screening material M and/or N; the body of the plate P (all or part); and/or the body of the support T (all or part).

“Composite” material as used herein includes, but is not limited to, the composite materials including resin or plastic or fiberglass or glass referred to in U.S. Pat. Nos. 6,335,101; 6,346,425; 6,352,779; 6,343,038; 6,355,206; 6,355,358; 6,361,860; 6,324,833; 6,324,833; and 6,358,603 and in the references cited in these patents—all fully incorporated here for all purposes. It is within the scope of the present invention to use for a part for a shale shaker (parts listed or mentioned above according to the present invention) a composite material with reinforcing wires, bars, cables, pieces, plates, rods and/or discs which are metal, wood or plastic and with and/or within a matrix of cement, fiberglass, and/or plastic, including, but not limited to, as disclosed in U.S. Pat. No. 6,358,603 and in the references referred to in this patent, all of which are incorporated fully herein for all purposes.

Any support according to the present invention with openings and/or with structure defining openings and/or with a base member or base members across the support may be made of plastic, metal (e.g. aluminum, aluminum alloy, steel, stainless steel), resin, fiberglass, and/or a combination of these materials, with or without nanomaterial therein.

In certain aspects, the present invention provides a screen assembly with a filtering element and a composite frame, the frame in certain aspects including, optionally, a top surface, a bottom surface, and a plurality of filtering element attachment points to which the filtering element is attached. The filtering element may be any known layer or layers of known screening material and/or mesh and/or support (e.g., plate, strips, grid). The frame has therein strengthening nanomaterial and, optionally, one or a plurality of strengthening members such as rods or tubes.

It is within the scope of the present invention to connect a screen layer or layers to a support using adhesive that has dispersed therein nanomaterial; or to apply nanomaterial in a separate step, before applying adhesive, after applying adhesive, or both, the adhesive with or without nanomaterial dispersed therein. It is within the scope of the present invention to connect screen layers using adhesive that has dispersed therein nanomaterial; or to apply nanomaterial in a separate step, before applying adhesive, after applying adhesive, or both, the adhesive with or without nanomaterial dispersed therein—and using the thus-connected screen layers as is or then connecting them to a support. In those instances in which nanomaterial is applied which is not in an adhesive, the nanomaterial may be applied: as discrete particles; as agglomerations of particles; in or on a carrier such as a film, tape, fabric, felt, contact sheet, or decal; in a fluid or slurry; and application may be by spraying, pouring, dusting, painting, magnetic application, coating, electrostatic application, or charged particle application.

In certain aspects, nanomaterial may be employed to connect screen layers together without a support, to connect together screen layers and a support, or to connect together screen layers and then to connect connected screen layers to a support by separate steps of nanomaterial application and adhesive application in any sequence or order and with any step repeated, e.g., to achieve a desired thickness of adhesive, a desired amount of nanomaterial, a desired location of nanomaterial with respect to screen material or support or both, and a desired location of different nanomaterials if different nanomaterials are used in different layers or locations of a screen and/or screen support.

It is within the scope of the present invention wherever a screen is shown with different layers, different screen parts, and different adhesive uses and locations, for different nanomaterial to be used for any different parts, layers, or locations; for example, and not by way of limitation, metal and non-metal nanotubes can be used in different locations; nanotubes of a first metal can be used in a first location and nanotubes of a second metal can be used in a second location; and nanomaterial of one size (e.g., particles of a first largest dimension or diameter or length) used in one area or layer and nanomaterial of another size (e.g., particles of a second largest dimension or diameter or length) used in another area or layer.

It is within the scope of the present invention to provide a screen with multiple screen layers without a support such as a plate, frame, strips or grid in which adhesive alone, with sufficient nanomaterial therein, when applied across a screen assembly surface provides adhesive members of sufficient strength (in certain situations, after curing, setting or hardening) to maintain the screen assembly integral for use on a vibratory separator or shaker.

It is within the scope of the present invention to provide a screen assembly with multiple layers of screen in which at least one layer does not have wires which include nanomaterial and another layer which has wires with nanomaterial.

FIG. 19A shows a support 190 which has a body 192 and a plurality of spaced-apart openings 191. FIG. 19B shows a member 194 with nanomaterial 196. The member 194 may be any suitable material which can hold the nanomaterial 196; e.g., but not limited to a contact sheet, a film, tape, fabric, or felt. A suitable adhesive or glue may be used to hold the nanomaterial to the member 194. The member 194 may be made of degradable material; material that can be heated off, burned off, or cooked off; or transparent material. One or both sides of the member 194 can have adhesive thereon to facilitate location and positioning of the member 194 with respect to the support 190 and/or there can be adhesive on one or both sides thereof to connect a screen layer or screen layers to the support 190.

As shown in FIG. 19C, the nanomaterial 196 is located around the openings 191 when the member 194 is applied to the support 190. Optionally, adhesive is used to connect the nanomaterial as shown in FIG. 19C to the support 190. The nanomaterial may simply serve as a strengthener for the support; or, as shown in FIG. 19D, the nanomaterial may combine with adhesive applied to a layer of screening material 197 (or to multiple layers) to enhance the securement of the material 197 to the support and/or to provide strength for the resulting screen assembly 198. In certain aspects, the adhesive 194, in sufficient amounts, is the adhesive that secures layers of screening material together and/or to a support.

It is within the scope of the invention for the member 194 to include and provide the adhesive for securing the screening material layer(s) to the support 190 or for the member 194 simply to provide the nanomaterial 196 to the support or to the screen assembly 198. It is within the scope of the present invention to provide the member 194 without the nanomaterial to provide the adhesive for securing layer(s) of screening material to a support or for connecting layers together when no support is used.

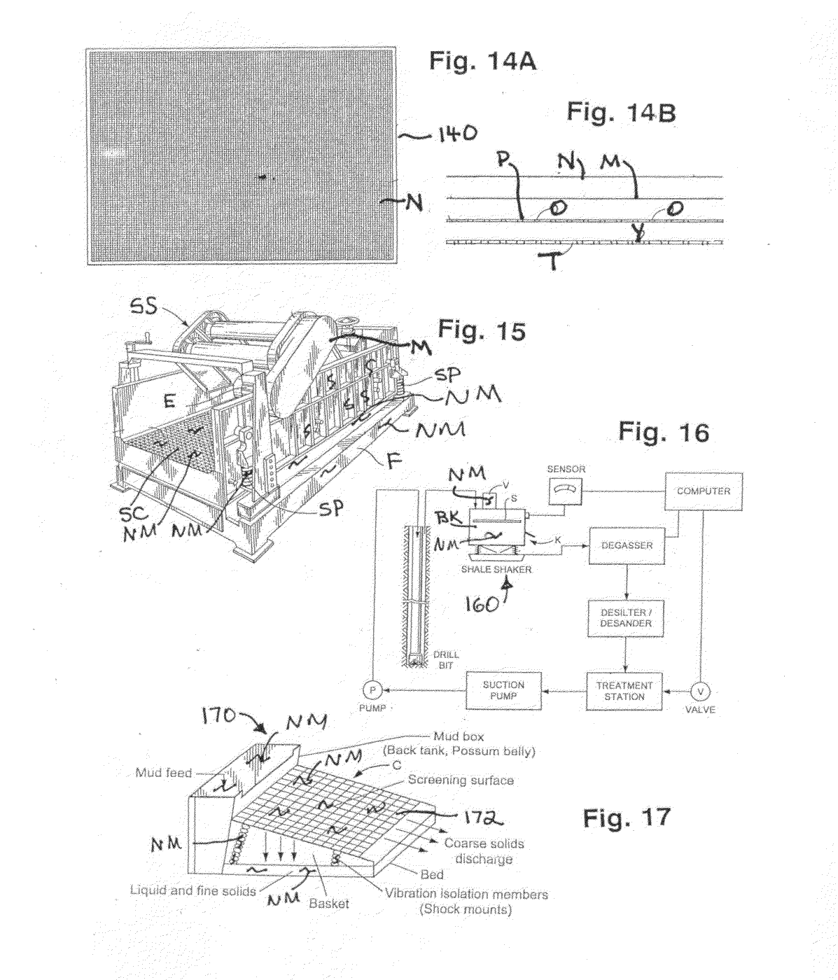

Referring now to FIG. 15, a shale shaker SS has a screen SC (any screen or screen assembly, screen or screen assemblies according to the present invention; with screen or screening cloth or mesh, layer or layers as desired) mounted on vibratable screen mounting apparatus or basket B mounted on springs SP (only two shown; two as shown are on the opposite side) which are supported from a frame F. The basket B is vibrated by a motor M and interconnected vibrating apparatus which is mounted on the basket B for vibrating the basket and the screens. Optional elevator apparatus E provides for raising and lowering of the basket end.

FIG. 16 discloses a shaker system 160 according to the present invention (e.g. as shown in U.S. Pat. No. 5,190,645 incorporated fully herein for all purposes, but with improvements according to the present invention). The system 160 has a shale shaker K having a screen or screens S according to the present invention. The screen(s) S are mounted in a shaker basket BK and one or more vibrators V (any known suitable shaker vibrator) vibrate the basket B and hence the screen(s) S. The other components of the system 160 may be any such suitable components as named, and are, e.g, as described in U.S. Pat. No. 5,190,645.

FIG. 17 shows schematically a system 170 according to the present invention with a Mud Box (Back tank, Possum Belly) to distribute material flow to a screening surface of screen(s) 172 according to the present invention. The screen(s) are mounted in a Deck (Basket) which is vibrated to assist the throughput of mud and movement of separated solids. The deck rests on Vibration Isolation Members, such as helical springs or rubber mounts. The vibration isolation members rest on the support member, which is also used to divert flow as desired, (a “Bed”).

Optionally, on a sloped deck (e.g. cascade or parallel flow), screens may be continuous with one screen covering the entire deck length, or with a divided deck which has more than one screen used to cover the screening surface, or with individual screens mounted at different slopes and/or different heights. There may be multiple decks, e.g., with more than one screen layer may be employed. In a two or three deck unit, the material, fluid, drilling fluid, or mud passes through one screen before flowing through another.

In the shakers and systems according to the present invention, including any of any drawing herein and those, e.g. those of FIGS. 15-17, parts of the shakers and of the screens may have dispersed therein nanomaterial NM for strengthening and/or for enhanced conductivities.

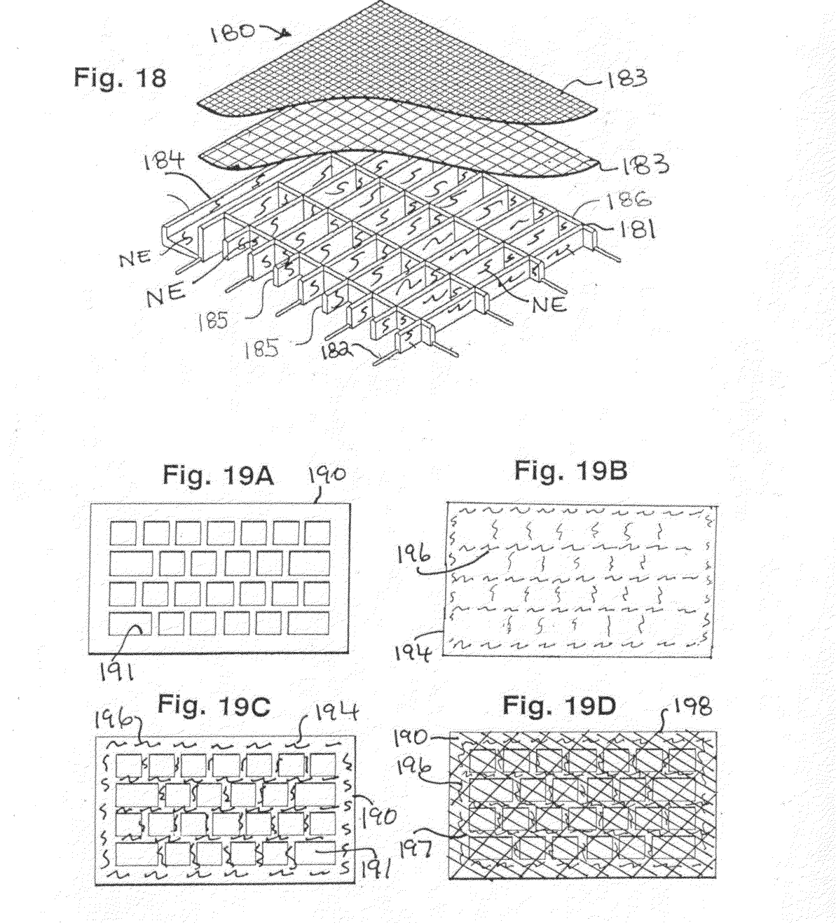

FIG. 18 shows a screen assembly 180 (in exploded view) which has a composite frame 181, an optional wire structure 182, and a plurality of screens or filtering elements 183. Optionally the screen assembly 180 also includes hookstrip attachment extensions 184 that provides a way to attach the screen assembly to a shaker body (not shown).

The composite frame 181 has therein nanomaterial NE and the composite frame 181 may be formed from any known material including, but not limited to, high-strength plastic, composite material, fiberglass, mixtures of high-strength plastic and glass, high-strength plastic reinforced with high-tensile-strength steel rods, and any combinations thereof. Additionally, composite frames 181 may be formed with integral wire structure 182. The frame may be made in any suitable manner known in the art, e.g., but not limited to, by injection molding and/or gas injection molding.

A wire grid may be made as a single longitudinal wire structure and a single latitudinal wire structure, e.g., as in U.S. Pat. No. 7,992,719.

The composite frame 181 may also be formed to include filtering element attachment points 185 located on a top surface 186 of composite frame 181. Optionally, the tops of the points 185 are ridged a shown or they may be flat. It is within the scope of the present invention to provide a screen assembly with strengthening nanomaterial in the connection material that secures layer(s) of screening material to a support (or to layers of screening material without a support) by applying nanomaterial to the layer(s) and then applying adhesive; or by using adhesive with nanomaterial therein to effect the connection; or both. It is also within the scope of the present invention to apply adhesive in multiple steps with different loadings of nanomaterial in the adhesive applied in different steps, e.g., to achieve different levels or amounts of nanomaterial at different locations and/or heights within a screen assembly.

As shown in FIG. 20A, an apparatus 200 applies nanomaterial 202 to a screen assembly 204 which has a support 205 with openings 205a and layers of screening material 201a and 201b. The apparatus can apply the nanomaterial 202 by gravity flow and/or induced flow (e.g., with a pneumatic stream). FIG. 20B illustrates the subsequent application of adhesive 203 by an application apparatus 206 to the screen assembly to secure the layers 201a and 201b to the support 205 and to encompass the nanomaterial 202 within the adhesive and within the layers 201a and 201b.

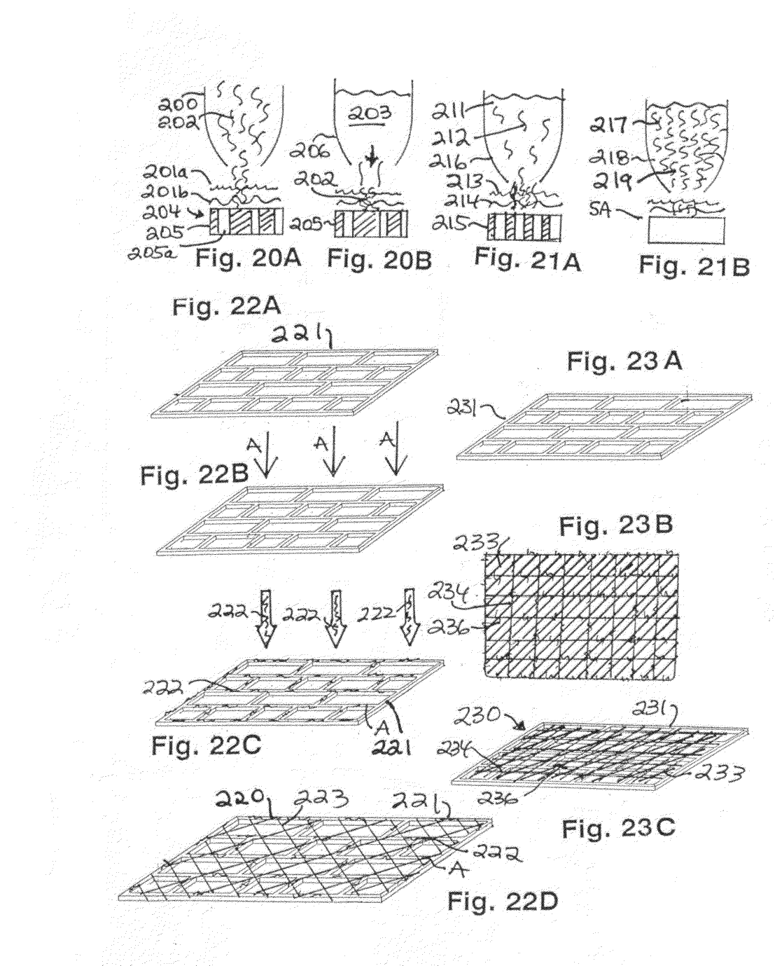

As shown in FIG. 21A, adhesive 211 with nanomaterial 212 therein may be applied by an apparatus 216 to secure layers 213 and 214 of screening material to a perforated support 215.

As shown in FIG. 21B, adhesive 217 with nanomaterial 218 therein may be applied to a screen assembly SA (which, in certain aspects, is a screen assembly resulting from the method shown in FIG. 20A. 20B or of FIG. 21A) with an apparatus 218. The adhesive 217 has a different loading of nanomaterial 219 which is greater than the loading of the nanomaterial 212 of FIG. 21A.

Also, optionally the adhesive 217 is different from the adhesive 211 and/or the nanomaterial 219 is different from the nanomaterial 212. It is within the scope of the present invention to apply the adhesive 217 with nanomaterial 219 before applying the adhesive 211 with the nanomaterial 212 to a screen assembly or to a layer or layers of screening material to be connected to a support.

FIG. 22A shows a frame 221 for a screen assembly 220 according to the present invention (FIG. 22D). As shown in FIG. 22B adhesive A is applied to the frame 221. Then, as shown in FIG. 22C, nanomaterial 222 is applied to the frame 221 and is held thereon by the adhesive A. As shown in FIG. 22D a layer 223 of screening material (or layers if desired) is secured to the frame 221 with or without the nanomaterial within connecting material used to connect the layer 223 to the frame 221.

FIG. 23A shows a frame 231 for supporting screening material 232 of a screen assembly 230 (FIG. 23C) according to the present invention. A combination of layers of screening material 233 and 234, secured together with adhesive with nanomaterial 236 therein, as shown in FIG. 23B, is connected to the frame 231 with any suitable adhesive and/or connectors to form the screen assembly 230.

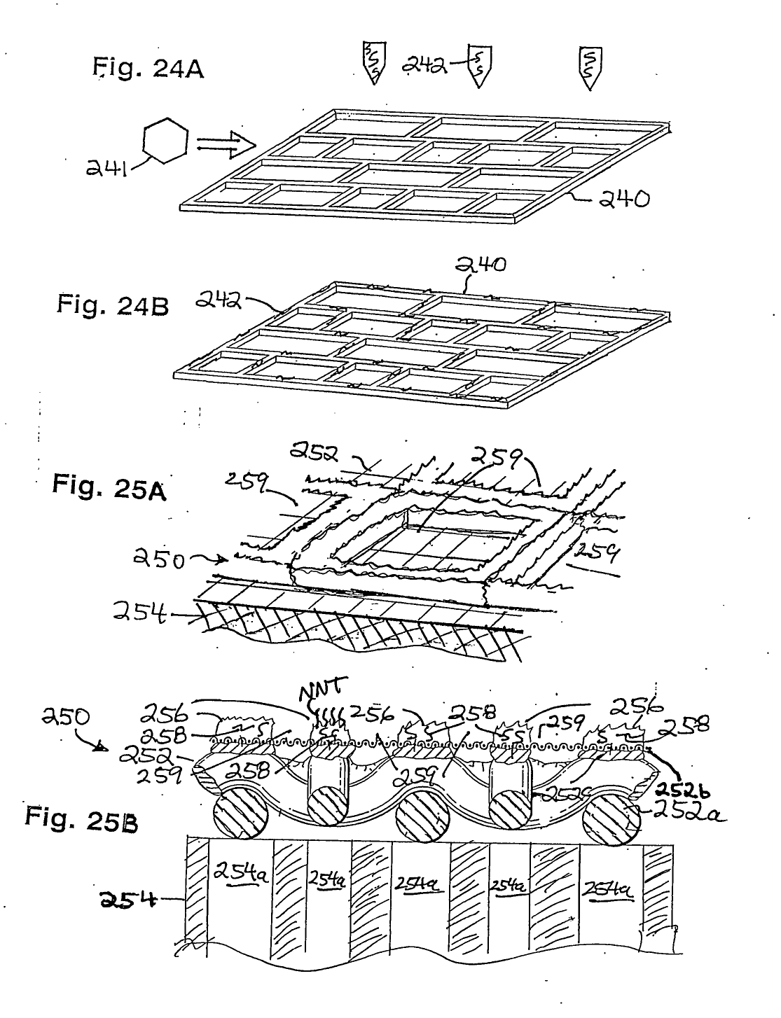

FIG. 24A illustrates a method according to the present invention for locating nanomaterial 242 on a support for a screen assembly according to the present invention. An apparatus 241 imposes a force on a frame 240, e.g., the frame is magnetized by the apparatus 241 (e.g., the apparatus 241 is an electromagnet apparatus) and the nanomaterial 242 is or includes or contains or is mixed with magnetically attractive material and/or magnetically attractive nanomaterial; or the nanomaterial 242 is electrostatically charged and the apparatus 241 charges the frame 240 so that the nanomaterial 242 is attracted to and deposited on the frame 240 (as shown schematically in FIG. 24B). Following the location of the nanomaterial 242 on the frame 240 the nanomaterial may be: adhered to the frame 240; a layer or layers of screening material may be placed on the frame on the nanomaterial, and then the layer(s) are adhered to the frame 240 with the nanomaterial; after a first layer of nanomaterial 242 is placed on and adhered to the frame 240, then a second layer of screening material is applied over the first, with or without an additional application of nanomaterial 242 or a different nanomaterial, and then the second layer (and any additional nanomaterial if present) is adhered to the frame and/or to the first layer; and/or adhesive with or without nanomaterial is applied to the frame to the height of the topmost surface of a layer or layers of screening material, to a level slightly above this height, or to a level significantly above this height.

As is true for any embodiment herein, when adhesive material (e.g., but not limited to, glue, epoxy, plastic) is applied so that there is set, cured or hardened adhesive material at a level above that of a topmost surface of a topmost screen layer, this adhesive is on parts of a support that define openings through the support or the adhesive, when there is no support present, forms boundaries of openings through the screening material. On the area within the boundaries provided by the adhesive material, mini-pools are formed whose bottoms are the layer or layers of screening material. Due to the formation of these mini-pools, fluid being treated by these screen assemblies is held on the screening surface for a relatively longer period of time and the fluid is screened for a longer time period and it is screened and more efficiently. The adhesive material forming the walls of these mini-pools can be any adhesive used in any embodiment of the present invention, with or without nanomaterial therein.

FIGS. 25A and 25B illustrates schematically a screen assembly 250 (shown partially) which may be a screen assembly according to the present invention (any disclosed herein) or may be a known screen assembly with improvements according to the present invention as described below. The screen assembly 250 has a layer or layers of screening material 252 (two layers shown, 252a and 252b) on an optional support 254 with openings 254a. Adhesive 256 with nanomaterial 258 dispersed therein is deposited on top of the topmost surface of screening.

As shown in FIGS. 25B and 25C, adhesive 256 applied to the top of the screening material layer(s) 252 projects above the top of the screening material and forms mini-pools 259. In one aspect, with the screen assembly 250 on a vibratory separator or shaker, fluid to be treated remains on top of the screening material 252 a relatively longer time when it is retained within a pool 259 (as compared to retention on the screen in the absence of such pools). Instead of adhesive, any suitable material with nanomaterial therein that may be stably secured to the screen surface may be used to form the pools.

As shown in FIG. 25B, the layer 252b is connected to the layer 252a with adhesive 252c. Optionally, or in addition to the adhesive 252c, the two layers may be sintered together or bonded together (as may be any two or three layers of any embodiment herein).

It is within the scope of the present invention for the height of the walls of the pools 259 on a screen 259s to be any desired height and for some or each wall to be a different height. For example, as shown in FIG. 25C, in the pool 259c, a wall 259a is shorter than a wall 259b. Such a pool may be oriented as desired on a screen; e.g., with fluid flowing over the screen 259s in a direction A or in a direction B. Fluid retention time within a pool may be adjusted by choosing particular wall heights and/or particular pool orientations on a screen.

It is within the scope of the present invention for a screen's surface to have mini-pools according to the present invention across substantially all of the screen surface or to have such mini-pools only at desired locations on a screen surface; for example, only at a fluid introduction end or a fluid exit end of a screen, or in an area of concentrated fluid flow. As shown in FIG. 26A, mini-pools 261 of a screen 262 extend from one end of the screen to the other and from side to side.

As shown in FIG. 26B, mini-pools 263 of a screen 264 extend down the middle of the screen 264.

As shown in FIG. 26C, mini-pools 265 are at a fluid introduction end of a screen 266; mini-pools 267 are in the middle of the screen 266; and mini-pools 268 are at a fluid exit end of the screen 266. Any set or any two sets of the mini-pools 265, 267, and 268 may be deleted.

It is within the scope of this invention to provide a screen with a screen support and/or screening material strengthened with nanomaterial and/or with nanomaterial for enhancing conductivity (e.g., thermal, energy, force, stress, or electrical conductivity) with nanomaterial either in substantially all of a screen support and/or in substantially all of the wires, fibers, filaments, members, or rods that make up screening material or screening area; or, alternatively, to use such nanomaterial only in selected areas of a screen, e.g. but not limited to at a fluid introduction end, at a fluid exit end, or at an area of concentrated fluid flow. As shown in FIG. 27A a screen 270 according to the present invention has nanomaterial 271 dispersed in a screen support 279 at a fluid introduction end of the screen and nanomaterial 272 dispersed in a fluid exit end of the screen. Also, it is within the scope of the present invention for the wires, etc. of screening material 278 to have nanomaterial dispersed therein.

As shown in FIG. 27B a screen 275 according to the present invention has nanomaterial 273 dispersed in a screen support 277 down the middle of the screen 275. Also, it is within the scope of the present invention for the wires, etc. of screening material 275m to have nanomaterial dispersed therein

The present invention provides improvements to the subject matter of U.S. Pat. No. 7,581,647 including adding nanomaterial to any composite or part disclosed in this patent (which is incorporated fully herein for all purposes). This patent has no teaching, motivation, or suggestion to make a shale shaker or parts of it with such composite material according to the present invention, and this is true of every prior patent cited herein.

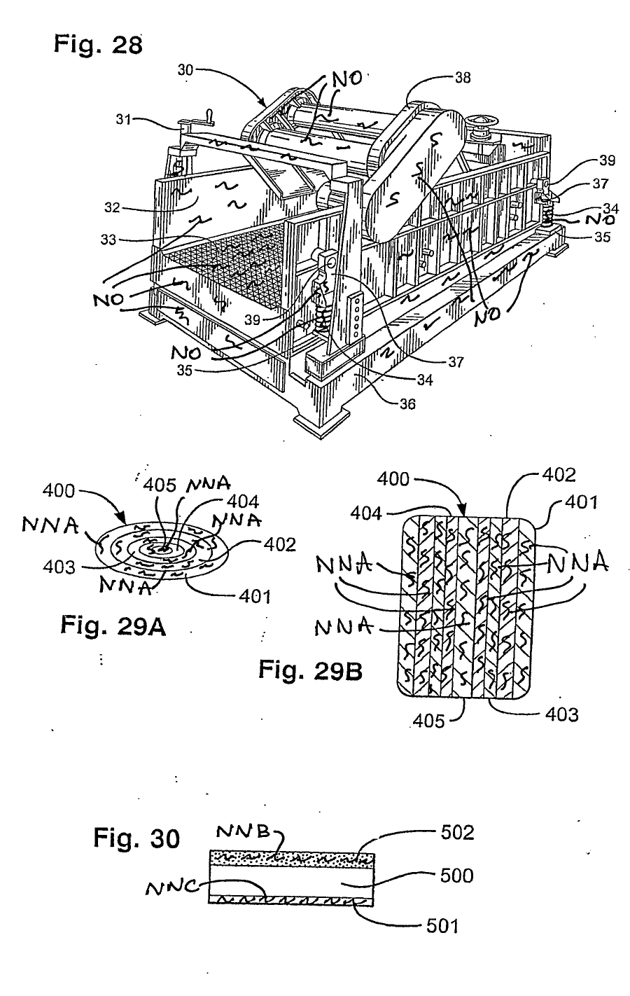

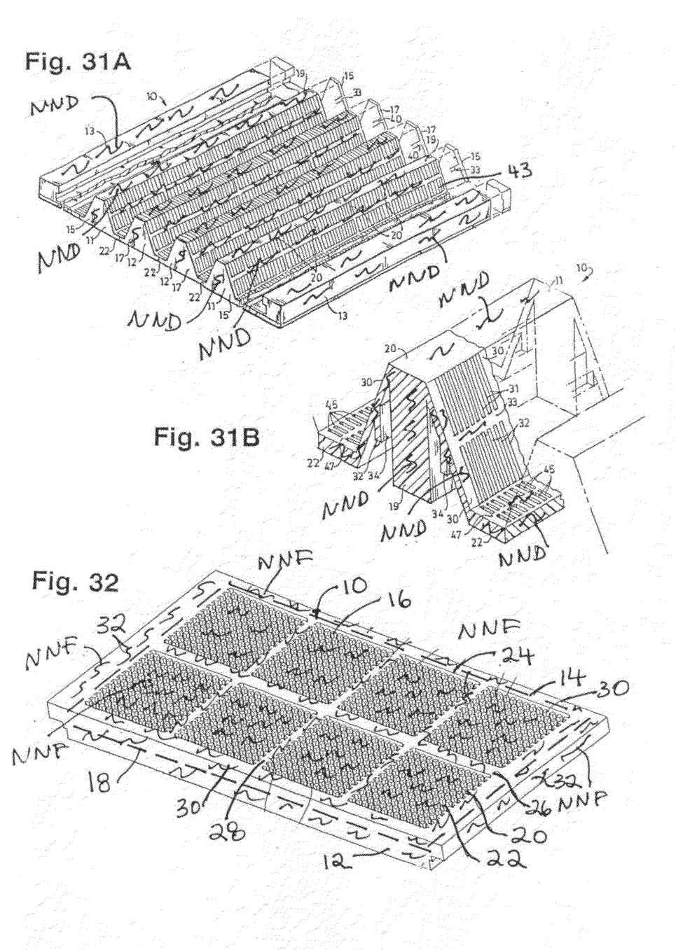

FIG. 28 shows a shale shaker 30 in accordance with the present invention, which has screen apparatus 33 mounted in a basket 32. Between basket mount members 37 and mount members 35 on a frame 36 are mounted springs 34 for isolating vibration of the shale shaker 30. Vibrating apparatus 38 vibrates the basket to vibrate the screen apparatus 33. Optional elevator apparatus 31 provides for raising and lowering of the basket end. Posts 39 secured to the basket 32 extend through corresponding holes in the mount members 37.

In accordance with the present invention, the screen apparatus 33 and/or the basket 32 are made of composite material with nanomaterial NO therein or thereon, as are, optionally, the mount members 37, frame 36 mount members 35, and posts 39.

FIGS. 29A and 29B disclose a structural member 400 in accordance with the present invention for use with vibratory separators and shale shakers. Although shown with a generally elliptical cross-section, any suitable cross-section may be used. In one particular aspect the member 400 is used for mounting springs or other isolators between a screen support and a base or housing; but it is to be understood that, in accordance with the present invention, such structure may be used for basket ends or walls, chutes, posts, and for supporting members or bases.

As shown the member 400 has a plurality of rings of different material. In one aspect rings 401 and 403 and a core 405 are made from relatively rigid composite material and the rings 402, 404 are made from flexible composite material.

Alternatively, the rings 402, 404 are made of the rigid material and the rings 401, 403 and core 405 are made of the flexible material. Optionally, all rings are made of the same material. It is within the scope of the present invention to use any desired number of rings of either material. Each ring or alternating rings is made of composite material with nanomaterial NNA therein. Each ring may have the same nanomaterial therein or different rings may have different nanomaterial therein. All rings may be deleted leaving only the core 405 or any desired number of rings may be used.

FIG. 30 shows a part of a screen or of a shaker or a wall or end 500 of a basket of a separator or shaker in accordance with the present invention. The wall or end 500 has a coating of composite material 501 which includes dispersed therein nanomaterial NNC. Optionally an opposing side of the end 500 has a layer of composite material 502 with nanomaterial NNC (which may be the same as or different from the nanomaterial NNB. Any composite material with nanomaterial disclosed herein may be used. In certain aspects the coating 501 is the thickness of one, two, three, four more layers of paint and the layer 502 ranges between 1/64th inch and ½ inch in thickness. Optionally be coating 501 is like the coating 66, FIG. 6.

“Composite” material as used herein includes, inter alia, fiberglass material and other non-metallic composite including, but not limited to, the composite materials referred to in U.S. Pat. Nos. 7,581,647; 6,335,101; 6,346,425; 6,352,779; 6,343,038; 6,355,206; 6,355,358; 6,361,860; 6,324,833; 6,324,833; and 6,358,603 and in the references cited in these patents—all fully incorporated here for all purposes. It is within the scope of the present invention to use for a part for a shale shaker (parts listed or mentioned above in accordance with the present invention) a composite material with reinforcing wires, bars, cables, pieces, plates, rods and/or discs which are metal, wood or plastic and with and/or within a matrix of cement, fiberglass, and/or plastic, including, but not limited to, as disclosed in U.S. Pat. No. 6,358,603 and in the references referred to in this patent, all of which are incorporated fully herein for all purposes—with or without nanomaterial dispersed therein.

The present invention provides, in certain aspects, a flat or an undulating molded plastic vibratory screen including a base, either a plurality of screening openings in the base; or a plurality of spaced substantially parallel undulations on the base, screen configurations on the undulations, and supporting rib structure within the undulations. In certain aspects the present invention provides improvements to the subject matter of U.S. Pat. No. 7,624,125 including plastic for any plastic part of the subject matter of this patent with nanomaterial dispersed therein (any nanomaterial disclosed herein). This patent has no teaching, motivation, or suggestion to make a separator, shale shaker or parts of it with such plastic material according to the present invention, and this is true of every prior patent cited herein.

An undulating molded plastic vibratory screen 10 of the present invention includes a plurality of major structural undulations 11 and a plurality of minor structural undulations 12. The major undulations 11 are interspersed with the minor undulations 12, and there are connecting portions 22 between the undulations 11 and 12. At the outer side edges of the screen, the plastic is, optionally, formed into channel configurations 13 which have optional reinforcing metal angle members molded therein which may extend throughout the entire lengths of the screen sides. The channels 13 are for receiving known channel-shaped tensioning members of a vibratory screening machine. The plastic has nanomaterial dispersed therein.

In one aspect, the screen 10 is molded in one piece and is of a size to fit across the bed of a vibratory screening machine. The screen is molded from any suitable plastic, including, but not limited to, MDI polyether type of polyurethane. Dispersed in the plastic is nanomaterial NND. Both ends of each major structural undulation 11 are closed by integrally molded end caps 15, and the ends of minor structural undulations 12 are closed by integrally molded end caps 17. The outer dimensions of the major and minor undulations may be the same. The undulations may have an internal rib structure with major ribs 19 and minor ribs 20 which may be molded integrally with major ribs 19.

The structural stability of the major undulations 11 may be enhanced by internal ribs 34 which may be molded integrally with portions 33 at the inner surface of each side 30. Ribs 34 extend between and their ends are molded to the minor ribs 20. The structural stability of the minor undulations 12 may be enhanced by internal ribs.

Each undulation 12 includes a screen configuration having two rows of slots 43 which are separated by central molded portions. At the connecting portions at 22 between the undulations 11 and 12, the screen 10 includes a screen configuration having two rows of slots 45 which are separated by a molded portion 47 therebetween which extends to the edges of the screen and may be molded integrally therewith.

The present invention provides a screening module with a frame component to be secured to an underlying screen deck, in use. The module has a screening panel carried by the frame component. The screening panel has an operatively upper screening surface and a support structure underlying the screening surface with a plurality of spaced protrusions being supported by and projecting up from the support structure. The module is made of material with nanomaterial dispersed therein.

The present invention provides improvements to the subject matter of U.S. Pat. No. 8,113,357 including materials for parts of modules with nanomaterial dispersed therein. This patent has no teaching, motivation, or suggestion to make a screen or module or parts thereof with such nanomaterial according to the present invention.

In FIG. 32 a screening module 10, in accordance with an embodiment of the invention has a frame component 12 and a screening panel 14 carried by the frame component 12. The frame component 12 and the screening panel 14 may be formed integrally as a one-piece unit. In one aspect, the module 10 is a one-piece moulding of a suitable plastic with nanomaterial NNF dispersed therein, or synthetic plastic material with nanomaterial, e.g., but not limited to, PVC, polyester resin, or a polyurethane material, e.g., a polyurethane material has a Shore Hardness in the range from about 85 to 93 depending on the application of the module 10.

The screening panel 14 defines a screening surface 16. A support structure may be arranged operatively below the screening surface 16. The support structure 18 (shown schematically in dotted line) supports a plurality of protrusions 20. The protrusions 20 project upwardly from the support structure 18 to any desired height or they terminate in a plane defined by the screening surface 16 of the screening panel 14. The protrusions 20 define, between them, a plurality of screening apertures 22. The apertures 22 may be arranged in a plurality of discrete aperture arrays 24. In this embodiment, there is a central member 26 of the module 10 and a plurality of lateral members 28 extending at right angles from the central member 26. These members 26, together with sides 30 and 32 of the module 10, effectively define the aperture arrays 24.

It is within the scope of the present invention to provide an undulating screen for a vibratory screening machine or shaker with a plastic layer or grid having nanomaterial therein. In certain aspects, such a screen for a vibratory screening machine or shaker includes an apertured plate, the plate with or without nanomaterial dispersed therein, and a bonded subassembly of an undulating support screen and fine screening screen and an optional finer screening screen bonded to each other by a fused plastic grid which includes plastic with nanomaterial dispersed therein, and bonded to the apertured plate.

The present invention provides a method of fabricating a screening screen assembly for a vibratory screening machine or shaker including the steps of providing a support screen, superimposing a plastic grid onto the support screen, optionally superimposing a finer screening screen onto the fine screening screen, applying heat and pressure to the superimposed screens to fuse the plastic grid (with nanomaterial therein) and thereby form a flat bonded laminate subassembly by causing the fused plastic grid to permeate the fine screen and, if present, the finer screen, and the support screen, forming the bonded laminate subassembly into an undulating shape, providing an apertured plate, the plate with or without nanomaterial dispersed therein, and bonding the undulating bonded subassembly to the apertured plate. Any of the screens may, optionally, be made with wires, filaments, rods, etc. with nanomaterial dispersed therein.

In certain aspects the present invention provides improvements to the subject matter of U.S. Pat. No. 5,417,793 (incorporated fully herein for all purposes) including plastic for any plastic part of the subject matter of this patent with nanomaterial dispersed therein (any nanomaterial disclosed herein). This patent has no teaching, motivation, or suggestion to make a separator, shale shaker or parts of it with such plastic material according to the present invention.

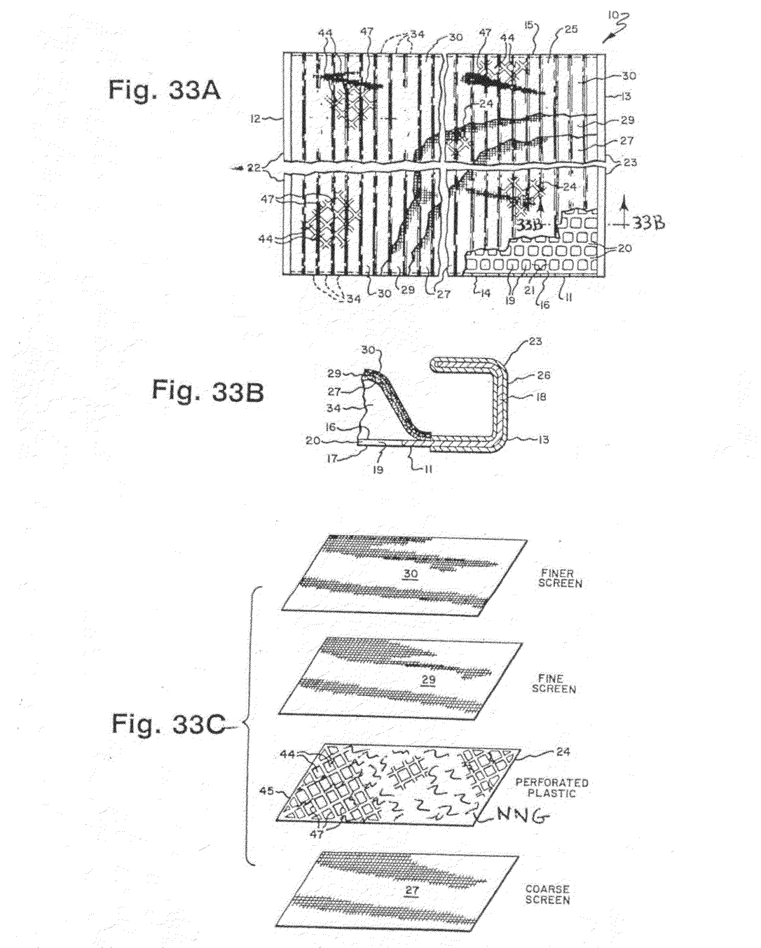

A screen assembly 10 as shown in FIG. 33A includes a frame in the form of a perforated metal plate 11, such as steel or any other suitable metal, having a first pair of opposite edges 12 and 13 and a second pair of opposite edges 14 and 15 and an upper surface 16 and a lower surface 17. Plate 11 includes apertures 19 which are bordered by elongated metal strip-like portions or members 20 which extend between edges 12 and 13 and by shorter strip-like portions 21 which extend lengthwise between elongated strip-like portions 20.

The openings 19 are, e.g., formed by a punching operation. Channel-shaped members 22 and 23 are mirror image counterparts and are constructed as shown in FIG. 33B. For example, an extension 18 of plate 11 is folded into a channel-shaped configuration and a member 26 is bent to the shape shown from a single piece of metal and it brackets the edge 13 in the manner depicted in FIG. 33B and it is welded thereto. Channel-shaped member 22 is of the same construction. The plate 11 may be a plate as set forth in U.S. Pat. No. 4,575,421. Any suitable plate, support, or any suitable frame which provides the frame portions or members to which a screen can be attached may be utilized.

The plurality of screens which are secured to plate 11 are bonded together into a subassembly by a perforated plastic grid 24 which has been fused into the screens by suitable heat and pressure. The grid 24 includes nanomaterial NNG dispersed therein (not to scale). The screen subassembly 25 includes a coarse screen 27 which serves a supporting function and may have mesh of any suitable measurement, including, but not limited to, a size of between 6 mesh and 20 mesh.

A fine screening screen 29 is bonded to coarse supporting screen 27 and it may have a mesh size of between 30 mesh and 325 mesh, or any other suitable size. A finer screening screen 30 is bonded to fine screening screen 29 and it may have a mesh size of between 40 mesh and 400 mesh, or any other suitable size. In certain aspects, the intermediate fine screen 29 is two U.S. sieve sizes coarser than the finer uppermost screen 30.

The three screens 27, 29 and 30 are bonded to each other by a fused plastic grid 24 which permeates all three screens. The screen subassembly 25 is formed in undulating curved shape and it has ridges and troughs. The undersides of troughs are bonded to plate 11 by a suitable adhesive such as epoxy. The epoxy may or may not have nanomaterial dispersed therein. In certain aspects, this bonding occurs, preferably, at all areas where the undersides of the troughs contact strips 20 and 21. The open ends of the ridges may be sealed or blocked by caps of any suitable material, e.g., but not limited to, polyurethane caps 34.

The screen assembly 10 can be mounted in a vibrating screening machine by means of elongated channel-shaped drawbars which engage channels 22 and 23, respectively.

In one aspect, the grid 24 is made with nanomaterial dispersed therein. Then the screen subassembly 25 with bonded screens 27, 29 and 30 is formed, in one particular method, with the screens 27, 29 and 30 and the plastic grid 24 superimposed in contiguous abutting relationship, and suitable heat and pressure are applied to bond the foregoing parts into a unitary configuration wherein the plastic grid 24 fuses in a controlled pattern and permeates the three screens 27, 29 and 30 and bonds them together, as can be seen from FIG. 33A.

The plastic grid 24 provides a gridwork within the screen assembly 25 wherein there are openings 44 between the plastic portions or areas of the grid 24 to provide unobstructed areas of the superimposed screens. The grid includes a border 45 and grid border portions 47 which outline openings 44. The plastic grid 24 is made of any suitable plastic, including, but not limited to, polyethylene, and in one aspect is approximately 0.062 inches thick, that is, before it is fused by heat and pressure into bonding relationship with screens 27, 29 and 30.

The bonding can be effected by pressing the superimposed abutting screens 27, 29 and 30 and plastic grid 24 with a heated platen. The temperature of the platen can be approximately 450 degrees F. and it is applied at a pressure of psi for approximately two minutes. Preferably, the polyethylene grid 24 is fused to a sufficient degree so that it will permeate the openings in screens 27, 29 and 30 and bond them together. Optionally the grid 24 is made of PVC or polyester resin with nanomaterial therein.

It will be appreciated that any other suitable plastic with nanomaterial dispersed therein, such as polypropylene, which is heat-fusible may be used. It will also be appreciated that the bonding temperatures, pressures, and times of pressing will vary with the plastic, its thickness, the types of screens being bonded, the amount of strength increase desired due to the addition of nanomaterial and/or the amount of enhanced conductivity due to nanomaterial, and other factors.

In certain aspects, the contacting portions of the screen subassembly 25 and plate 11 are bonded to each other by epoxy, with or without nanomaterial dispersed therein, as mentioned above. This bonding can be effected by dipping a heated perforated plate 11 into a fluidized powdered epoxy bed, which optionally contains nanomaterial dispersed therein, so that the powdered epoxy (in one aspect with nanomaterial) adheres to the plate. The plate with a layer of powdered epoxy (in one aspect with nanomaterial) thereon is then cooled. Thereafter, it is reheated to 350 degrees F., and a suitable press (not shown) is used to hold the undersides of the troughs of the screen subassembly 25 in engagement with plate 11 for approximately three minutes and the epoxy fuses into the undersides of the troughs of the screens. After the epoxy cools, the undulating screen is bonded to the plate. Such a method may also be used for any flat screening material, layer or layers according to the present invention. Any suitable known technique of bonding powdered epoxy may be used. Nanomaterial may be added to the epoxy prior to use with respect to the screen; or it may be added into epoxy that is on or in a screen which has not yet cured.

If desired, the screen subassembly can be adhesively secured to plate 11 by the use of liquid epoxy, with or without nanomaterial dispersed therein, which is applied to the upper surface of the plate. It will be appreciated that any other suitable method of bonding the screen subassembly to the plate may be used.

After the undulating screen subassembly 25 has been bonded to plate 11, the open ends of the ridges 31 may be sealed. In one aspect, this sealing is done as described in U.S. Pat. No. 5,417,793. In this respect, a chilled block is provided, and the edge of the screen assembly 10, such as 14, is placed in abutting relationship therewith. The block is chilled, e.g., to −50 degrees F. by passing suitable refrigerant through a coil therein. Thereafter, a syringe containing liquid polyethylene, with or without nanomaterial dispersed therein, is inserted through various of the apertures 19 adjacent edge 14 to supply polyurethane of sufficient depth to form caps 34. The chilled plate hastens solidification of caps 34. The same procedure is applied at edge 15.

In certain aspects, the present invention provides a coated screen for a vibratory separator or shaker that is coated with a coating that includes nanomaterial dispersed therein and a material, e.g. a polymer, PVC, or polyester resin that renders a surface more slick than when the coating is absent. Any suitable material, e.g, but not limited to polymer, may be used including but not limited to, polytetrafluoroethylene, arylene sulfide, and their equivalents.

In certain aspects in which the part 500 shown in FIG. 30 is a screen according to the present invention, the coating is a coating for rendering the screen surface slicker, the coating including nanomaterial dispersed therein, e.g., the coating 501 (or like the coating 66, FIG. 6).

In one aspect, a screen is provided with a solid arylene sulfide polymer-polytetrafluoroethylene coating that is suitable for use in a solids separating device.

The present invention provides improvements to the subject matter of U.S. Pat. No. 3,963,605 including materials with a suitable polymer and nanomaterial dispersed therein. This patent has no teaching, motivation, or suggestion of such coatings according to the present invention.

The present invention, in certain aspects, provides a metal substrate with openings to form a screen, the substrate coated with a coating that renders a surface more slick with nanomaterial dispersed therein, in one aspect a cured blend with from about 99 to 25 percent by weight polyarylene sulfide and from about 1 to 75 percent by weight fluoroethylene, with between 0.1 wt % to 2.0 wt % nanomaterial, the nanomaterial in one aspect being carbon nanotubes. The substrate (as is true for any support of any embodiment herein) may be any suitable substrate, including but not limited to, a metal substrate which is perforated metal, expanded metal, or woven screening.

In one aspect, a screen is provided which has a screen base, metal or non-metal, coated with a mixture of a material, e.g. a solid polymer, with nanomaterial mixed therewith or dispersed therein, optionally with polytetrafluoroethylene, and in one aspect solid arylene sulfide polymer and polytetrafluoroethylene.

Any coating according to the present invention is of any desired suitable thickness. In certain aspects, coatings are about 0.0015 to about 0.006 inches thick.

In certain aspects, the present invention provides a method of using an erosion resistant device for use in an oil and gas operation or a solids control or separation operation including: using an erosion resistant device which is one of a part of a vibratory separator, shale shaker, or screen, which part is made of base material with nanomaterial dispersed therein, the part having an erosion resistant surface having an array of elastic whiskers attached to, connected to, grown on, and/or adhered to the erosion resistant surface; and, in certain aspects, wherein the array of elastic whiskers reduces a speed of a particle impacting the erosion resistant surface thus reducing an erosion rate of the erosion resistant surface.

Such a part according to the present invention may have one or some (so long as they are not contradictory) of the following aspects or features: the elastic whiskers being of a material with an elastic modulus of between 250 giga-pascals and tera-pascal; the array of elastic whiskers is dense; is a forest of nanotubes, carbon or otherwise; is a forest of vertically-aligned nanotubes; is a forest of nanotubes, carbon or otherwise, between 0.5 micrometers and 50 micrometers in length, between 1 micrometers and 30 micrometers in length, or between nanometers and 100 nanometers in diameter; wherein the nanotubes, carbon nanotubes or otherwise, are densely packed and strongly bonded to the surface. In any embodiment herein (in which it is not contradictory) any such nanotubes may be the nanomaterial in and/or dispersed within a thing or material.

The present invention provides an erosion resistant device including: a component having an erosion resistant surface having an array of elastic whiskers; wherein the array of elastic whiskers is a forest of nanotubes, e.g., a dense forest or a forest of vertically-aligned nanotubes, carbon nanotubes or otherwise; and wherein the erosion resistant device is one of a part of a vibratory separator, part of a shale shaker, or part of a screen for a separator or shaker. In one aspect, the array of elastic whiskers is on a flexible substrate on the erosion resistant surface of the erosion resistant device.

In certain embodiments, a network of tubes, fibers or filaments that make up the forest are densely packed and strongly bonded to the surface to be protected. Tubes, fibers or filaments with a high elastic modulus may be used as well as fibers hard enough to resist the cutting action of solids that the surface will encounter.

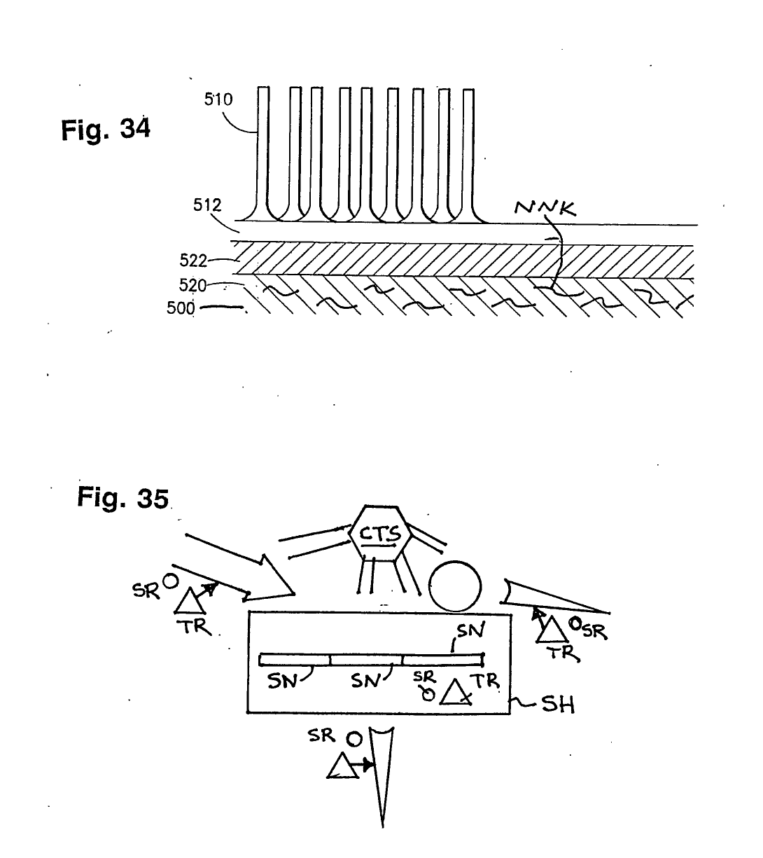

As shown in FIG. 34, a surface 520 of a part 500 of a separator, shaker or screen has a flexible carbon nanotube forest 510 attached to the surface 520, e.g., with an adhesive or an appropriate bonding material 522. Optionally, the forest 510 is on a flexible substrate 512. The bonding material 522 may be chosen to fasten the flexible substrate 512 to the surface 520, such as an epoxy, and may be used in combination with other processing steps to pre-condition either the flexible substrate 512 or the surface 520 to better adhere to the bonding material 522. The part 500 has nanomaterial NNK dispersed therein. The material 522 may have nanomaterial dispersed therein.

In certain aspects, the part 500 with the surface 520 is a support (e.g., frame, grid, panel, plate, strips, large mesh screen, expanded metal) for a shale shaker screen or for a screen for a vibratory separator. In other aspects, it is a part of a shale shaker (any part of any shaker or separator described or disclosed herein).

FIG. 35 shows schematically a system 350 according to the present invention for killing living things in fluid and material flowing to and from a vibratory separator or shale shaker. A separator or shaker SH has screens SN (one screen may be used) mounted in a basket BK which is vibrated by vibratory apparatus VA. A stream A is fed to the separator or shaker SH. The stream A can be any stream fed for treatment to a separator or shaker. The screens SN screen out at least one component of the stream A (e.g., but not limited to solids in drilling fluid).

The screened-out component or components flows off the tops of the screens SN in a stream B. The portion of the stream A that is not screened out flows in a stream C down and away from the screen SN.

Living things in each stream are killed by a killing treatment apparatus TR. Optionally, a sensor SR senses the presence of living things to be killed in a stream. A control system CTS is in communication with all the sensors and all the killing treatment apparatuses TR, and with the vibratory apparatus VA (and with any other apparatus that controls flow to and from the separator or shaker and/or controls screen angle or basket angle).

Any one or two killing treatment apparatuses TR may be deleted. Any treatment apparatus may be used only when a sensor senses living things in a stream. Optionally, any screen SN may be a “killer screen” as disclosed in U.S. application Ser. No. 13/374,243 filed Dec. 16, 2011 (fully incorporated herein for all purposes). Optionally the separator or shaker SH may be separator or shaker as disclosed in U.S. application Ser. No. 13/374,243 filed Dec. 16, 2011.

Either continuously, periodically, or only when living things are sensed, the killing treatment apparatuses TR are activated to kill living things in their associated stream. Such killing can be by feeding killing material into the stream and/or by applying killing energy to the living things in the stream. The killing material may be any such material that kills the living things desired to be killed, e.g., but not limited to, known biocides, in solid and/or liquid form, including, but not limited to acids, alkaline material, and any known biocide (and any such material disclosed in U.S. application Ser. No. 13/374,243). The killing energy may be any suitable energy in any form to kill the living things desired to be killed, e.g., but not limited to, heat, electrical current, microwaves, radio waves, light, laser beam, ultraviolet light, infrared light, and vibratory energy (and any such energy disclosed in U.S. application Ser. No. 13/374,243).

The control system CTS can control the input and rate of feed of killing material or energy; shut down the separator or shaker SH, e.g., but not limited to, in the event of an overload of living things; provide alerts and/or alarms regarding events occurring in treatment of material and/or the presence of living things in any and all streams; record the events and the composition of each stream and provide a record of events and stream composition; provide a real-time analysis of each stream; and/or monitor screen performance and condition, in one aspect in real time.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. The inventor may rely on the Doctrine of Equivalents to determine and assess the scope of the invention and of the claims that follow as they may pertain to apparatus and/or methods not materially departing from, but outside of, the literal scope of the invention as set forth in the following claims. All patents and applications identified herein are incorporated fully herein for all purposes. It is the express intention of the applicant not to invoke 35 U.S.C. §112, paragraph 6 for any limitations of any of the claims herein, except for those in which the claim expressly uses the words ‘means for’ together with an associated function. In this patent document, the word “comprising” is used in its non-limiting sense to mean that items following the word are included, but items not specifically mentioned are not excluded. A reference to an element by the indefinite article “a” does not exclude the possibility of one or more of the element, unless the context clearly requires that there be one and only one of the elements.

1.-40. (canceled)

41. A screen for a vibratory separator, the screen comprising
a support,
screening material on the support,
the support having nanomaterial therein.

42. The screen of claim 41 wherein the vibratory separator is a shale shaker.

43. The screen of claim 41 wherein sufficient nanomaterial is present to enhance strength of the support.

44. The screen of claim 41 wherein sufficient nanomaterial is present to enhance a conductivity of the support, the conductivity being one of thermal conductivity, electrical conductivity, and mechanical force conductivity.

45. The screen of claim 41 wherein the support has a total mass, and the nanomaterial is carbon nanotubes present as between 0.0001 weight percent to 90 weight percent of the total mass of the support.

46. The screen of claim 41 wherein connecting material connects the screening material to the support, the connecting material having strengthening nanomaterial therein.

47. The screen of claim 46 wherein the connecting material has a total mass and the nanomaterial is present as between 0.1 wt percent to 2 wt. percent of the total mass of the connecting material.

48. The screen of claim 41 wherein the nanomaterial is one of nanotubes, nanostructures, nanocomposites, nanopastes, nanohorns, coated nanomaterial, nanomatrices, ceramic nanomatrices, nanoplatlets, nanoflakes, carbon nanotubes single-wall carbon nanotubes (SWNTs), multi-wall carbon nanotubes (MWNTs), double-wall carbon nanotubes (DWNTs), buckytubes, fullerene tubes, tubular fullerenes, graphite fibrils, carbon nanofibers, and functionalized nanotubes.

49. The screen of claim 41 wherein the support is one of plate, grid, panel, strip, frame, unibody structure, expanded metal, and large mesh screen.

50. The screen of claim 41 wherein the support is made of composite material.

51. The screen of claim 41 further comprising
a seal for sealing an interface between the screen and another thing,
the seal made of seal material with nanomaterial therein.

52. The screen of claim 41 wherein the support comprises
a base,
at least one crossmember extending across the base,
the at least one crossmember made of material with nanomaterial therein.

53. The screen of claim 41 wherein the screen has a fluid introduction end, a middle, and a fluid exit end, the support having nanomaterial at one of the fluid introduction end, the middle, and the fluid exit end, or at all three.

54. The screen of claim 53 wherein the screening material has nanomaterial therein.

55. The screen of claim 41 wherein the screening material is one of flat and non-flat.

56. The screen of claim 41 wherein the nanomaterial has a shape with a diameter in the range 10-500 nm and a length in the range 1-10 mumicrons.

57. The screen of claim 41 wherein the screening material is connected to the support with connecting material which is one of glue, epoxy, plastic, bonding material, fiberglass, sewing material, welding material, composite material, epoxy system and adhesive.

58. A screen for a vibratory separator, the screen comprising
a support,
screening material on the support,
the support having nanomaterial therein and is one of plate, grid, panel, strip, frame, unibody structure, expanded metal, and large mesh screen,
the support having a total mass, and the nanomaterial is carbon nanotubes present as between 0.0001 weight percent to 90 weight percent of the total mass of the support,
the screen having a fluid introduction end, a middle, and a fluid exit end, the support having nanomaterial at one of the fluid introduction end, the middle, and the fluid exit end, and
the nanomaterial has a shape with a diameter in the range 10-500 nm and a length in the range 1-10 mumicrons.

59. A screen for a vibratory separator, the screen comprising
a support,
screening material on the support,
connecting material connecting the screening material to the support, the connecting material having strengthening nanomaterial therein,
the connecting material having a total mass and the nanomaterial is present as between 0.1 wt percent to 2 wt. percent of the total mass of the connecting material,
wherein the nanomaterial is one of nanotubes, nanostructures, nanocomposites, nanopastes, nanohorns, coated nanomaterial, nanomatrices, ceramic nanomatrices, nanoplatlets, nanoflakes, carbon nanotubes single-wall carbon nanotubes (SWNTs), multi-wall carbon nanotubes (MWNTs), double-wall carbon nanotubes (DWNTs), buckytubes, fullerene tubes, tubular fullerenes, graphite fibrils, carbon nanofibers, and functionalized nanotubes.

60. A shale shaker comprising
a screen with a support,
screen mounting structure,
vibratory apparatus for vibrating the screen mounting structure,
a screen with a support, the screen mounted on the screen mounting structure,
screening material on the support,
connecting material connecting the screening material to the support, and
one or both of the support and the connecting material having strengthening nanomaterial therein.
